(19) United States
(12) Patent Application Publication
(10) Pub. No.: US 2026/0168171 A1
(43) Pub. Date: Jun. 18, 2026

(54) SYSTEMS AND METHODS FOR PROCESSING BLACK LIQUOR SOLUTIONS

(71) Applicant: Via Separations, Inc., Watertown, MA (US)

(72) Inventors: Nathaniel KRAFT, Westwood, MA (US); Cole Joseph HARRIS, Boston, MA (US); Kyle VANZANDT, Watertown, MA (US); Marcus LUNDGREN, Cambridge, MA (US); George VOSS, Cambridge, MA (US); Samuel RAE, Somerville, MA (US); Ella RICHARDS, Boston, MA (US); Brandon Ian MACDONALD, Maynard, MA (US); Brent D. Keller, Somerville, MA (US)

(21) Appl. No.: 19/263,364

(22) Filed: Jul. 8, 2025

Related U.S. Application Data
(63) Continuation of application No. PCT/US2024/010720, filed on Jan. 8, 2024.
(60) Provisional application No. 63/437,963, filed on Jan. 9, 2023.

(51) Int. Cl. D21C 11/00; B01D 61/02; B01D 61/14; B01D 69/04; B01D 71/02

(52) U.S. Cl. CPC D21C 11/0042; B01D 61/025; B01D 61/027; B01D 61/145; B01D 69/04; B01D 71/02

(57) ABSTRACT

Systems and methods for concentrating black liquor solutions using pressure driven filtration processes are disclosed herein. The systems and methods described herein integrate multiple unit operations with graphene oxide membranes filtration devices to accomplish concentration of black liquor streams. These systems and methods provide a lower energy, more economical solution than the currently deployed technology of thermal evaporation.

### CROSS-REFERENCE TO RELATED APPLICATIONS

This application is a continuation of International Patent Application No. PCT/US2024/010720, entitled “Systems and Methods for Processing Black Liquor Solutions,” filed Jan. 8, 2024, which claims priority to and the benefit of U.S. Provisional Patent Application 63/437,963, entitled “Systems and Methods for Processing Black Liquor Solutions,” filed Jan. 9, 2023, the disclosure of each of which is incorporated by reference herein in its entirety.

### TECHNICAL FIELD

The present disclosure relates systems and methods for concentrating black liquor solutions using pressure driven filtration processes, and more specifically to systems and methods that integrate multiple unit operations with graphene oxide membranes to accomplish a lower energy and more economical solution to concentration of black liquor streams.

### BACKGROUND

Black liquor is a byproduct of the kraft pulping process which is generated during digestion of pulpwood to produce cellulose fibers for pulp and paper products. Black liquor contains the residual pulping residues, primarily lignin and hemicellulose, inorganic chemicals from the kraft process such as sodium hydroxide and sodium sulfate, as well as other extractives contained in the wood such as tall oil. Pulp mills generally process black liquor using multi-effect thermal evaporators to increase the solids content in the black liquor from 10-15% to 65-80%. The high solids content black liquor is then burned in a recovery boiler to generate steam, providing energy to the pulp mill and recovering the chemicals used in the cooking process. Thermal evaporation is a slow and energy intensive process that has a considerable impact on the kraft mill energy consumption, efficiency, and cost. Consequently, there is a need in the art for new systems and methods for processing black liquor that address the shortcomings of thermal evaporators and provide a pathway to costs reduction and higher efficiency mill operation.

### SUMMARY

Embodiments described herein relate generally to systems and methods for concentrating black liquor solutions using pressure driven filtration processes comprising graphene oxide membranes. One aspect of the of the present disclosure relates to a system, comprising: a feed preparation component, a first filtration module, a second filtration module, a third filtration module, and a fourth filtration module. The feed preparation component is configured to receive a black liquor feed having an initial total concentration of dissolved and suspended solids, the feed preparation component being further configured to remove the suspended solids from the black liquor feed to produce a conditioned feed. The first filtration module includes a graphene oxide membrane. The first filtration module is fluidically coupled to the feed preparation component and configured to contact the conditioned feed at a predetermined temperature with the graphene oxide membrane to produce a first concentrate and a first permeate. The second filtration module is fluidically coupled to the first filtration module. The second filtration module is configured to receive the first permeate and produce a second concentrate and a second permeate. The third filtration module is fluidically coupled to the second filtration module. The third filtration module is configured to receive the second permeate and produce a third concentrate and a third permeate. The fourth filtration module is disposed downstream the third filtration module. The fourth filtration module is configured to receive the third permeate and produce a processed permeate, wherein the first, the second, and the third concentrate are combined to produce a processed concentrate having a total concentration of solids higher than the initial total concentration of solids.

In some embodiments, the feed preparation component is further configured to remove a portion of the dissolved solids from the black liquor feed to produce the conditioned feed.

In some embodiments, the initial total concentration of solids is between about 10 and 15 wt. % and the graphene oxide membrane produces the first permeate having a total concentration of solids of no more than about 7 wt. %.

In some embodiments, the graphene oxide membrane produces the first concentrate having a total concentration of solids of at least about 15 wt. %.

In some embodiments, the predetermined temperature is at least about 70° C.

In some embodiments, the graphene oxide membrane has a total solids rejection rate of at least about 50% at the predetermined temperature and a pressure of no more than 800 psi.

In some embodiments, the first filtration module further includes a primary stage that accommodates the graphene oxide membrane, the primary stage configured to recirculate a portion of the first concentrate to the conditioned feed

In some embodiments, the filtration module further includes a primary stage and a secondary stage. The primary stage accommodates a first graphene oxide membrane. The primary stage is configured to (1) contact the conditioned feed with the first graphene oxide membrane to produce an intermediate concentrate, and (2) recirculate a portion of the intermediate concentrate to the conditioned feed. The secondary stage accommodates a second graphene oxide membrane. The secondary stage is disposed downstream from the primary stage and is configured to contact the intermediate concentrate with the second graphene oxide membrane to produce the first concentrate.

In some embodiments, the secondary stage is configured to recirculate a portion of the first concentrate to the conditioned feed.

In some embodiments, the feed preparation component includes one or more tubular ceramic membranes.

In some embodiments, the second filtration module includes a polymeric membrane. The second filtration module is configured to contact the first permeate with the first polymeric membrane to produce the second concentrate and the second permeate.

In some embodiments, the first permeate is contacted with the first polymeric membrane at a temperature of no more than about 50° C. and a pressure of about 700-1100 psi.

In some embodiments, the polymeric membrane produces the second permeate having a total concentration of solids of no more than about 3 wt %.

### BRIEF DESCRIPTION OF THE DRAWINGS

FIG. 1 schematically illustrates an example system for processing a black liquor (BL) feed, according to an embodiment.

FIG. 2 shows a distribution of diameters from fibers recovered from a black liquor feed, analyzed using a Scanning Electron Microscope (SEM).

FIG. 3 is a table depicting a list of feed treatment and/or a separation devices that can be included in the feed preparation component, with their estimated minimum pore size and ability to be operated continuously.

FIG. 4 is a plot of permeate total dissolved solids (Permeate TDS) as a function of volume concentration factor (VCF) for a black liquor feed processed with exemplary ceramic membranes.

FIG. 5 is a plot of pressure differential as a function of time measured across a set of membranes included in a filtration module flowing an untreated black liquor (BL) feed and a black liquor (BL) feed treated with a feed preparation component that includes a 50 μm felt bag filter.

FIG. 6 schematically illustrates a feed preparation component that integrates a heat exchanger and a feed treatment/separation device for processing a black liquor (BL) feed, according to an embodiment.

FIG. 7 is schematic diagram of an arbitrarily-size graphene oxide membrane configuration in which two graphene oxide membranes are disposed parallel to each other to receive a feed and produce a concentrate fluid and a permeate fluid, according to some embodiments.

FIG. 8A is a plot of the total solids rejection rate as a function of time for an example polymeric reverse osmosis (RO) membrane operating in a black liquor solution at 63° C.

FIG. 8B is a plot of the total solids rejection rate as a function of time for an example graphene oxide membrane operating in a black liquor solution at 70° C.

FIG. 9A is a plot of the flux in gallons per foot square per day (GFD) of a polymeric reverse osmosis (RO) membrane as a function of total concentration of solids present in the feed.

FIG. 9B is a plot of the flux in gallons per foot square per day (GFD) of a high solids content reverse osmosis (RO) polymeric membrane as a function of total concentration of solids present in the feed.

FIG. 10A is a plot of the flux in gallons per foot square per day (GFD) as a function of time for a polymeric ultrafiltration (UF) membrane having a molecular weight cutoff of about 10 kDa during operation in a black liquor feed.

FIG. 10B is a plot of the flux in gallons per foot square per day (GFD) as a function of time for a graphene oxide membrane during operation in a black liquor feed.

FIG. 11 shows a plot of the flux in gallons per foot square day (GFD) produced by a nanofiltration (NF) membrane and a reverse osmosis (RO) membrane as a function of concentrate total dissolved solids.

FIG. 12A is a table depicting a comparison of the concentration of species of a processed permeate and a combined condensate from an evaporator system.

FIG. 12B is a table depicting total concentration of dissolved solids and conductivity of a permeate produce after each filtration module, according to an embodiment

FIG. 13 schematically illustrates an example system for processing a black liquor (BL) feed, according to an embodiment.

FIG. 14 shows a plot of membrane flux in gallons per foot square day (GFD), permeate conductivity (mS/cm) and permeate refractive index (Brix) as a function of black liquor conditioned feed total dissolved solids (TDS) for a graphene oxide membrane coated on a nanofiltration membrane serving as support (e.g., a GO/NF membrane) and a graphene oxide membrane coated on a reverse osmosis membrane serving as support (e.g., a GO/RO membrane) according to an embodiment.

FIG. 15 is a table summarizing flux in (GFD) and permeate total dissolved solids (TDS) of a graphene oxide membrane operating in a Black liquor feed at different operating pressures, according to an embodiment.

FIG. 16 is a table summarizing the number of filtration modules and the type of membrane include in each filtration module for a system for processing a black liquor (BL) feed, according to an embodiment.

### DETAILED DESCRIPTION

Black liquor is a byproduct of the kraft pulping process, generated during conversion of wood into cellulose fibers for pulp and paper products. Black Liquor produced in pulp mills can contain sodium sulfate, sodium carbonate, sodium hydrosulfide, sodium thiosulfate, and/or sodium hydroxide, residual fibers from the pulping process, as well as larger size (e.g., high molecular weight) organic species including hemicellulose, cellulose, and lignin, among others. In some instances, black liquor streams can have a total concentration of solids in the range of approximately 10 to 20 wt. %. Existing methods and/or approaches for treatment of black liquor streams typically consists of feeding the black liquor into a series of thermal evaporators to remove water until the solids content in the black liquor is increased to about 65 to 80 wt. %. The black liquor with high solid content is then fed into a recovery boiler to generate steam and recover the pulping chemicals used during the kraft process. The evaporated water is condensed and recycled for future use within the mill. This method and/or approach to process black liquor is energy intensive, and accounts for approximately 30% of the overall kraft mill energy consumption.

Pressure driven membrane separation is a technology that can be up to 90% more energy efficient than thermal evaporation, since separation of species via a membrane eliminate the need for a liquid to vapor phase transition required in thermal evaporators. Consequently, the use of pressure driven membranes for processing black liquor provides an opportunity for costs savings to mills through reductions in energy usage and/or consumption. Polymeric membranes constitute one of the most common types of membranes used in pressure driven separation and/or purification applications. Polymeric membranes lead the membrane separation industry due to their high performance, ease of fabrication in large quantities, and overall cost. Polymeric membranes can be made using multiple monomers, selected to impart desired characteristics to the membrane including temperature stability, mechanical strength, and/or affinity to specific species and/or component to be separated. Polymeric membranes, and more specifically reverse osmosis (RO) membranes, have been used commercially in a wide range of applications including water purification, desalination, wastewater treatment, bio purification, and concentration, removal, and purification of different salts, small molecules, and macromolecules. Despite these advantages, use of (RO) membranes to process black liquor has been limited. The majority of (RO) membranes have been designed for separating species at moderate temperatures, such as for example 35 to 45° C. Black liquor is produced at higher temperatures, such as for example 90° C., and thus processing black liquor requires membranes capable of exhibiting thermal stability, high performance, and durability under those operating conditions. The use of heat exchangers to decrease the temperature of the black liquor solutions and enable the use of (RO) membranes has proven impractical due to the associated operational expenses. Additionally, reducing the temperature of black liquor can lead to precipitation of one or more components and/or species which have limited solubility in black liquor streams. The precipitation of solids species from black liquor streams can cause membrane fouling and increased pressure differential across the membrane, which can drastically reduce the durability of the membrane. The present disclosure provides systems and methods for the processing of black liquor that address the limitations of current membranes and exhibit one or more superior properties over existing membranes. At least by integrating different unit operations that include graphene oxide membranes and (RO) membranes in particular sequences and/or approaches, the systems and methods described herein can accomplish the concentration of black liquor and provide a lower cost and higher energy efficiency alternative to prior art thermal evaporators.

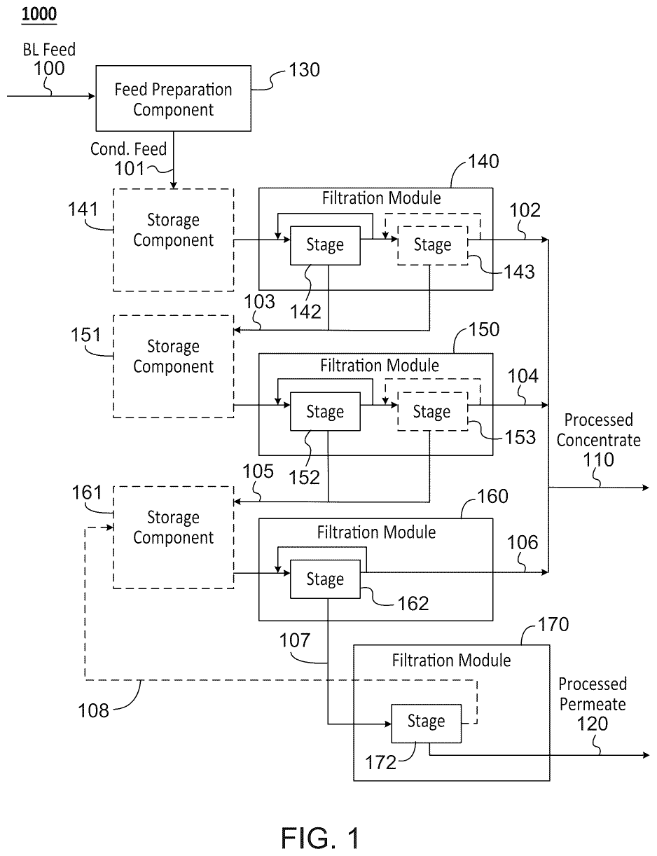

Now referring to the drawings, FIG. 1 shows a schematic illustration of an example system 1000 for the processing of a black liquor feed, according to an embodiment. The system 1000, which can also be referred here as the “black liquor processing system 1000” or the processing system 1000″ can be configured to receive a black liquor (BL) feed 100 and process it to produce a processed concentrate 110 and a processed permeate 120 with a set of desired and/or target characteristics such as a target conductivity and/or a target total dissolved solids (TDS). The processing system 1000 includes a feed preparation component 130, a filtration module and/or component 140, a filtration module and/or component 150, a filtration module and/or component 160, and a filtration module and/or component 170. Optionally, in some embodiments, the processing system 1000 can include storage components 141, 151, and 161 coupled to the filtration modules 140, 150, and 160, respectively. FIG. 1 shows the feed preparation component 130 of the processing system 1000 can receive the BL feed 100, conduct one or more preparation and/or conditioning steps and produce a conditioned (Cond.) feed 101. The BL feed 100 can be any suitable black liquor stream produced in a mill having a total concentration of solids in the range of approximately 10 to 20 wt. %.

The feed preparation component 130 can be configured to conduct the one or more preparation and/or conditioning steps to remove materials suspended on the BL feed 100 including residual fibers produced during the pulping process, and/or a portion (or all) of the large size organic species dissolved in the BL feed 100. For example, in some embodiments, the feed preparation component 130 can be configured to remove a majority of the residual fibers and other suspended materials present in the BL feed 100. In other embodiments, the feed preparation component 130 can be configured to remove a majority of the residual fibers and other suspended materials, as well as a portion of the large size organic species dissolved in the BL feed 100 (e.g., the hemicellulose, cellulose, lignin, and the like). Said in other words, the feed preparation component 130 can be configured to receive a BL feed 100 which contains an initial amount of dissolved and suspended solids (e.g., an initial total amount of solids), and remove a portion of the initial total amount of solids in the BL feed 100, producing a conditioned feed 101. In some embodiments, the feed preparation component 130 can be configured to remove a percentage of the initial total amount of solids in the BL feed 100, including, for example, about 10%, about 15%, about 20%, about 30%, about 40%, about 50%, about 60%, about 70%, about 80%, about 90%, or about 100%, inclusive of all values and ranges therebetween. In some embodiments, the feed preparation component 130 can include one or more heat exchangers (not shown in FIG. 1) that can be used to adjust the conditioned feed 101 to a predetermined temperature. The conditioned feed 101 can then be directed and/or flown to the filtration module 140 at the predetermined temperature for further processing until generating the processed concentrate 110 and the processed permeate 120, as further described herein. Optionally, in some embodiments, the conditioned feed 101 can be stored in a storage compartment 141 prior to being directed to the filtration module 140, as further described herein.

The feed preparation component 130 can include any suitable feed treatment and/or a separation device configured to receive the BL feed 100 and remove the suspended solids and/or the large size organic species dissolved on the BL feed 100 to produce the conditioned feed 101. The suspended solids present in the BL 100 feed primarily consist of residual fibers generated during the kraft pulping process at a concentrations of about 10 to 1000 mg/L. The large size dissolved organic species includes, for example, hemicellulose, cellulose, lignin. Removal of these fibers and the large size dissolved organic species protects pumps, membranes, heat exchangers, and other components of the processing system 1000 from fouling, and/or accumulation of debris leading to reduced flow rates, increased pressure drop, overheating and/or other unwanted effects. Fouling of the membranes and/or other components of the processing system 1000 can be extremely difficult to reverse and thus can lead to permanent degradation in performance.

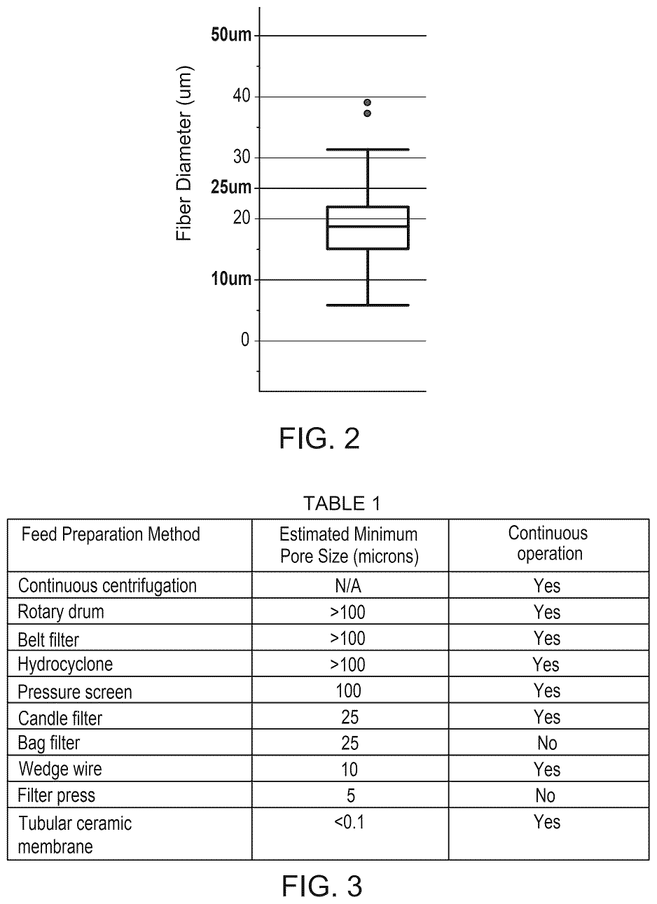

The feed preparation component 130 can include a feed treatment and/or a separation device characterized by small pore size separating media, high stability at elevated temperatures and alkaline conditions, and ability to operate continuously with a minimal number of cleaning cycles. In particular, the feed preparation components 130 can include one or more feed treatment and/or separation devices comprising separating media with an average pore size smaller than the average size of the fibers and other materials suspended on the BL feed 100. In that way, flowing and/or passing the BL feed 100 trough the feed treatment and/or a separation devices included in the feed preparation component 130 results in retention of a majority of fibers and other materials suspended on the BL feed 100. In some embodiments, the separating media can also retain a portion (or all) of the large size dissolved organic species (e.g., the hemicellulose, cellulose, lignin, and the like), while allowing passage of other dissolved solids including any remaining portion and/or fraction of the large size dissolved organic species, as well as other species including sodium sulfate, sodium carbonate, sodium hydrosulfide and the like. FIG. 2 is an outlier box plot displaying a distribution of diameters from fibers recovered from a black liquor feed obtained by analyzing Scanning Electron Microscope (SEM) images of the recovered fibers. FIG. 2 displays a rectangular box enclosing the bulk of the diameter data obtained. More specifically, the lower end of the rectangular box represents the 25^{th} quantile of the diameter data (˜15 μm), the upper end of the rectangular box represents the 75^{th} quantile of the diameter data (˜23 μm), and the horizontal line within the rectangular box represent the median diameter (˜18 μm). The vertical lines that extend from the lower and upper ends of the rectangular box in FIG. 2 represent the outermost data points within 1.5 times the 25^{th} and 75^{th} quantile. Inspection of the data shown in FIG. 2, reveals the majority of fibers suspended in a black liquor feed have a diameter between about 5-25 μm. Consequently, in some embodiments the feed preparation component 130 can include one or more feed treatment and/or separation device characterized by a pore size that prevents passage of any fibers and/or suspended materials with dimensions of about 5 μm or larger.

In some embodiments, the feed preparation component 130 can include one or more feed treatment and/or a separation devices characterized by an average pore size of no more than about 25 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 0.9 μm, no more than about 0.8 μm, no more than about 0.7 μm, no more than about 0.6 μm, no more than about 0.5 μm, no more than about 0.4 μm, no more than about 0.3 μm, no more than about 0.2 μm, or no more than about 0.1 μm, inclusive of all values and ranges therebetween.

In some embodiments, the feed preparation component 130 can include one or more feed treatment and/or a separation devices characterized by a molecular weight cutoff (MWCO) of about 1 kDa, about 2 kDa, about 4 kDa, about 6 kDa, about 8 kDa, about 10 kDa, about 12 kDa, about 14 kDa, about 16 kDa, about 18 kDa, about 20 kDa, about 25 kDa, about 50 kDa, about 100 kDa, about 150 kDa, or about 200 kDa, inclusive of all values and ranges therebetween.

In some embodiments, the feed preparation component 130 can include one or more pressure screens, wedge wire filters, centrifugation devices, mesh or felt sock filters, or the like, characterized by an average pore size consisted with the ranges disclosed above (e.g., an average pore size of about 0.1-25 μm). In some embodiments, the feed preparation component 130 can include a clean-in-place (CIP) mechanism that enable continuous operation of the feed preparation component 130, avoiding interruptions caused by accumulation of fibers and other materials removed from the BL Feed 100 over time. For example, in some embodiments, the feed preparation component 130 can include CIP mechanisms such as backflushing, mechanical cleaning or chemical treatment. In a preferred embodiment, the feed preparation component 130 can include one or more ceramic membranes having any suitable shape/form (e.g., tubular and/or planar or flat sheet). The ceramic membranes can include single-channel and/or multi-channel geometry comprising a separating media having an average pore size of about 1 kDa to about 10 μm. The ceramic membranes can be configured to have an average pore size smaller than the average size of the fibers and other materials suspended on the BL feed 100, such that the ceramic membranes prevent passage of those materials (e.g., the ceramic membranes reject the residual fibers and other materials suspended materials). Additionally, the average pore size of the ceramic membranes can also facilitate removing and/or rejecting a portion of the large size dissolved organic species (e.g., the hemicellulose, cellulose, lignin, and the like). For example, in some embodiments the ceramic membranes can remove and/or reject a percentage of the large size organic species dissolved in the BL feed 100 of about 10%, about 15%, about 20%, about 30%, about 40%, about 50%, about 60%, about 70%, about 80%, about 90%, or about 100%, inclusive of all values and ranges therebetween.

In some embodiments, the feed preparation component 130 can include a first group of feed treatment and/or a separation devices characterized by small pore size (e.g., an average pore size of about 1 kDa to about 10 μm) and a second group of feed treatment and/or a separation devices characterized by an intermediate average pore size (e.g., an average pore size of about 10-100 μm). In some embodiments, the first group of feed treatment and/or separation devices can include, for example, one or more ceramic membrane, filter press, and/or wedge wire. The first group of feed treatment and/or a separation devices of the feed preparation component 130 can be used to remove fibers suspended in the BL feed 100, stemming from the digestion of pulpwood in the Kraft process. In some embodiments, the first group of feed treatment and/or a separation devices can also remove a portion (or all) of the large size dissolved organic species (e.g., the hemicellulose, cellulose, lignin, and the like). In some embodiments, the second group of feed treatment and/or separation devices can include, for example, one or more bag filter, candle filter, pressure screen, and/or belt filter. The second group of feed treatment and/or a separation devices can be used to remove other materials suspended on the BL feed 100 whose average particle size is larger than 10 μm. In such embodiments, the feed preparation component 130 can be configured to receive the BL feed 100, and then flow the BL feed 100 to the second group of feed treatment and/or a separation devices (either in a series, a parallel, and/or a combination of series/parallel approach). Exposure of the BL feed 100 to the second group of feed treatment and/or a separation devices can facilitate removal of very large matter suspended on the BL feed 100, which if not removed first, may cause extensive damage, and/or increased pressure drop on the first group of feed treatment and/or a separation devices which have a much smaller average pore size. Following the exposure of the BL feed 100 to the second group of feed treatment and/or a separation devices, the BL 100 feed can then be directed to the first group of feed treatment and/or a separation devices to remove the suspended fibers produced in the Kraft process and/or the large size dissolved organic species.

FIG. 3 shows a table depicting a list of various feed treatment and/or a separation devices that can be included in the feed preparation component 130, with their estimated minimum pore size and ability to be operated continuously. In some embodiments, each one of the feed treatment and/or a separation devices described above, including those shown in FIG. 3, can be operated in multiple stages and/or passes as necessary to achieve the desired reduction in fiber content and/or other suspended solids, as well as a portion (or all) of the large size dissolved organic species. In some embodiments, the feed preparation component 130 can include various feed treatment and/or a separation devices coupled and/or combined to achieve a desired removal of fibers and/or other materials suspended in the BL feed 100. For example, in some embodiments the feed preparation component 130 can include one or more wedge wire filters and one or more tubular ceramic membranes fluidically coupled and/or combined to achieve a desired level of removal of fibers and other suspended materials present in the BL feed 100.

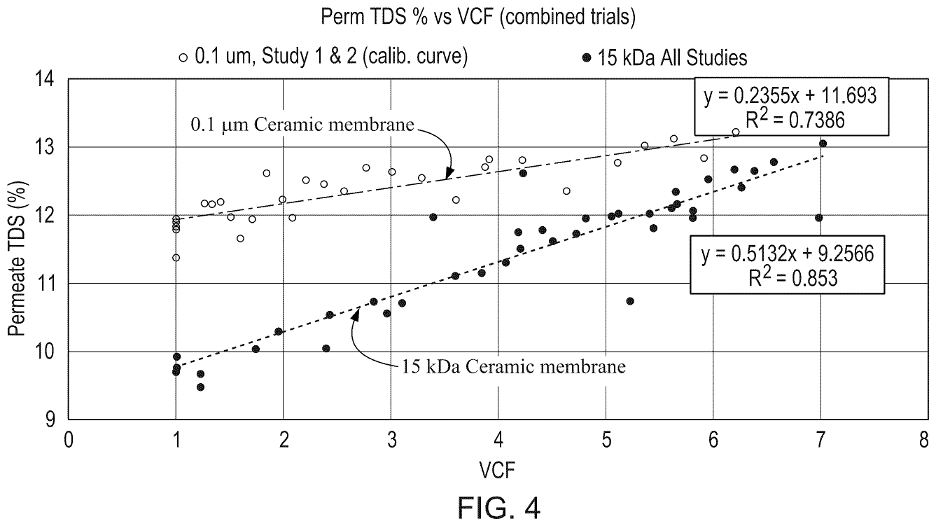

As described above, in some embodiments the feed preparation component 130 can include one or more ceramic membranes (tubular ad/or flat sheet) having an average pore size of about 1 kDa to about 10 μm. In particular, in some embodiments the feed preparation component 130 can include one or more tubular ceramic membranes arranged and/or disposed in either in a series, a parallel, and/or a combination of series/parallel configuration, with the tubular ceramic membranes comprising a separating media having a relatively small average pore size of no more than about 100 nm, no more than about 80 nm, no more than about 60 nm, no more than about 40 nm, no more than about 20 nm, no more than about 15 nm, no more than about 10 nm, no more than about 8 nm, no more than about 7 nm, no more than about 5 nm, no more than about 4 nm, or no more than about 3 nm, inclusive of all values and ranges therebetween. In some embodiments the feed preparation component 130 can include one or more tubular ceramic membranes arranged and/or disposed in either in a series, a parallel, and/or a combination of series/parallel configuration, with the tubular ceramic membranes comprising a separating media having a relatively small average pore size of no more than about 300 kDa, no more than about 250 kDa, no more than about 200 kDa, no more than about 150 kDa, no more than about 100 kDa, no more than about 80 kDa, no more than about 60 kDa, no more than about 40 kDa, no more than about 20 kDa, no more than about 10 kDa, no more than about 5 kDa, no more than about 1 kDa, no more than about 800 Da, no more than about 700 Da, no more than about 600 Da, no more than about 500 Da, or no more than about 400 Da, inclusive of all values and ranges therebetween. The use of tubular ceramic membranes with such small average pore size can facilitate the removal of suspended fibers and large size dissolved organic species (e.g., the hemicellulose, cellulose, lignin, and the like) producing a concentrate stream (not shown in FIG. 1) and permeate stream (e.g., a Cond. Feed 101 in FIG. 1) characterized by relatively low amounts of total dissolved solids (TDS). For example, FIG. 4 shows a plot of TDS present on a permeate stream (e.g., a stream similar to the Cond. feed 101 in FIG. 1) produced by a feed preparation component 130 includes different tubular ceramic membranes operating on a BL feed 100. More specifically, FIG. 4 shows the permeate TDS (%) as a function of volume concentration factor (VCF, a ratio of the volume and/or volumetric flowrate of the BL feed 100 to the volume and/or volumetric flow rate of the permeate stream produced) for a first tubular ceramic membrane having an average pore size of about 0.1 m and a second tubular ceramic membrane having an average pore size of about 15 kDa. FIG. 4 reveals that decreasing the average pore size of the tubular ceramic membrane from 0.1 μm to 15 kDa results in formation of permeates with substantially lower TDS for a wide ranges of volume concentration factors. For example, exposure of a BL feed 100 to the tubular ceramic membrane with average pore size of about 15 kDa at a VCF of 3.0 produces a permeate with a TDS of about 10.8%. Exposure of the same BL feed 100 to the tubular ceramic membrane with average pore size of 0.1 μm at the same VCF of 3.0 produces a permeate with a TDS of about 12.6%.

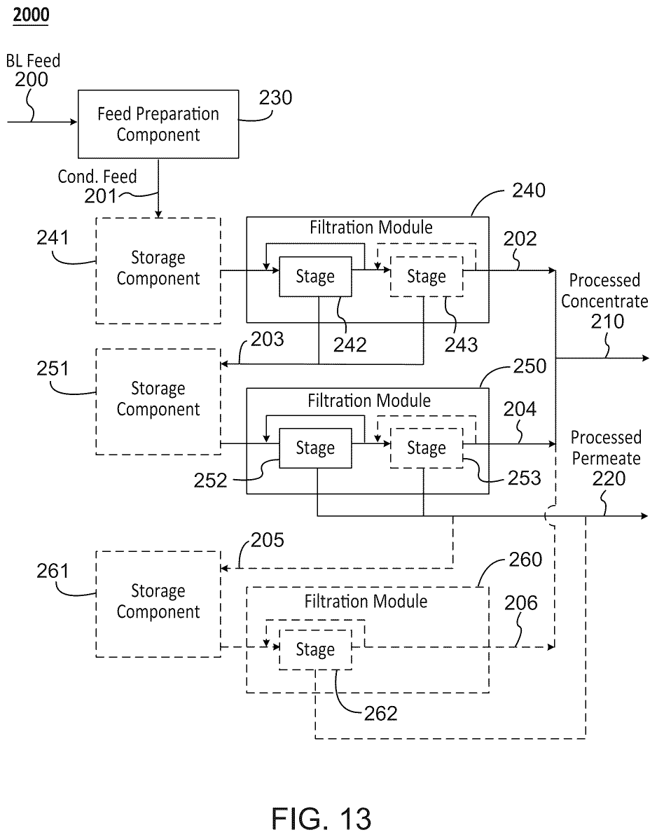

Reducing the TDS in the BL feed 100 using tubular ceramic membranes with small average pore size (as described above) can enable the system 1000 to achieve performance targets (e.g., a processed concentrate 110 and a processed permeate 120 having a set of desired and/or target characteristics such as a target conductivity and/or a target TDS) with a reduced number of filtration modules and/or passes, as further described herein. Said in other words, in some embodiments the use of a feed preparation component 130 comprising one or more tubular ceramic membranes with small average pore size such as those described above enables the system 1000 to produce a conditioned feed 101 with low TDS (e.g., a TDS of about 4 to about 18 wt. %). This low TDS in the conditioned feed 101 requires a reduced number of passes and/or filtration modules to produce a concentrate 110 and a permeate 120 with a set of desired and/or target characteristics (e.g., target conductivity and/or TDS), circumventing the need for all the passes and/or filtration modules of the processing system 1000 as shown in FIG. 1. Such embodiments will be further disclosed with reference to FIG. 13.

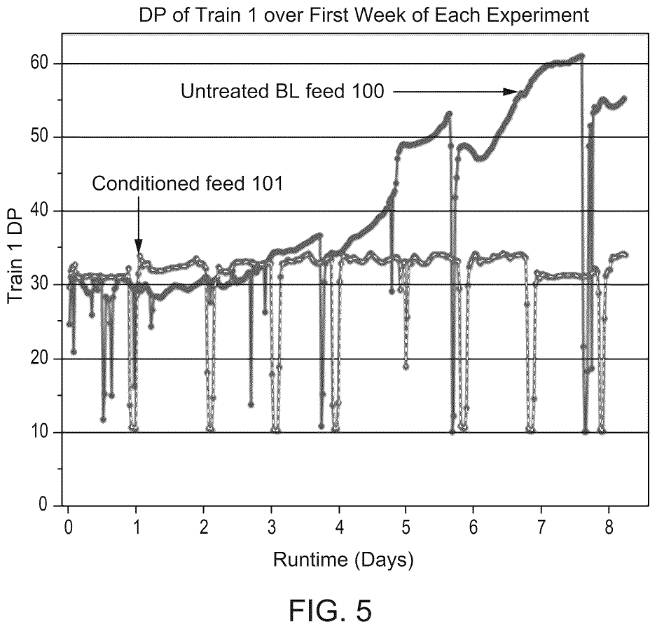

The feed preparation component 130 can have a direct impact on the pressure differential (dP) observed on a set of filtration modules 140, 150, 160 and 170. Ineffective removal of fibers and other materials suspended in the BL feed 100 can lead to an increased dP caused by fibers that become stuck, fixed, stapled, and/or attached to, for example, a membrane feed spacer of a filtration module. FIG. 5 shows a plot of pressure differential as a function of time measured across a set of membranes included in the processing system 1000 (e.g., a set of membranes included in the filtration modules 140, 150, 160 and 170 shown in FIG. 1) when flowing an untreated BL feed 100 and a conditioned feed 101 (e.g., a black liquor feed treated with a feed preparation component 130 that includes a 50 μm felt bag filter). The dP profile observed for the untreated BL feed 100 remains relatively constant for the first day of operation and then increases progressively until nearly doubling the initial pressure differential after just 8 days of operation of the processing system 1000. The increased dP observed with the untreated BL feed 100 can lead to reduced membrane flux, loss of performance, and mechanical failure of the membranes and/or other components of the filtration modules resulting in higher operating costs and limited efficiency. The dP profile observed for the conditioned feed 101 shows an initial pressure differential similar in magnitude to that of the untreated BL feed 100. However, unlike the untreated BL feed 100, the conditioned feed 101 remains relatively constant during the first 8 days, demonstrating the impact of the feed preparation component 130 on the stability of the processing system 1000.

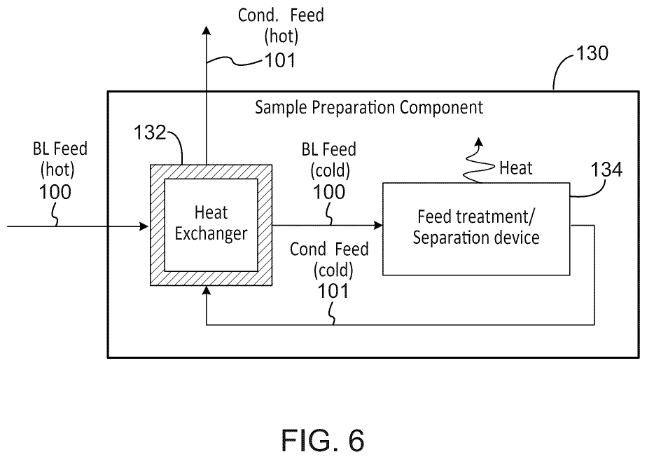

As described above, in some embodiments the feed preparation component 130 can include one or more heat exchangers (not shown in FIG. 1) that can be used to adjust the conditioned feed 101 to a predetermined temperature prior to directing the conditioned feed 101 to the filtration module 140 for further processing. In some embodiments, the BL feed 100 can be directed to a feed treatment and/or separation device to produce the conditioned feed 101, and then the conditioned feed 101 can be sent to a heat exchanger to adjust its temperature to a predetermined value (e.g., a predetermined temperature). FIG. 6 shows a schematic representation of such embodiment. More specifically, FIG. 6 shows the feed preparation component 130 can include a heat exchanger 132 disposed downstream from a feed treatment and/or separation device 134. The feed treatment and/or separation device 134, which can also be referred as the “separation device 134” herein, can be similar to and/or the same as any of the of feed treatment and/or a separation devices disclosed above. The separation device 134 can receive a hot BL feed 100 and remove the residual fibers and other materials suspended in the BL feed 100. Optionally, in some embodiments, the separation device 134 can also remove a portion of the large size dissolved organic species such as hemicellulose, cellulose, lignin. Because sufficiently high temperatures (e.g., above 75° C.) can cause damage to one or more subcomponents of the separation device 134 (e.g., damage to a filter, screen, membrane and/or ancillary subcomponents), in some embodiments the separation device 134 can include a cooling system. For example, in some embodiments the separation device 134 can include a passive cooling system. The passive cooling system may include uninsulated piping, a membrane housing, or a combination thereof. In some embodiments, the passive cooling system may include suitable heatsinks configured to conduct heat away from one or more subcomponent of the separation device 134 such as a membrane, a screen and/or a filter. The heatsinks may be formed from any suitable metal (e.g., copper, aluminum, steel, and the like). In some implementations, the heatsinks may include fins configured to dissipate heat into surrounding ambient air. Additionally, or alternatively, in some embodiments the separation device 134 can include an active cooling system. The active cooling system may include fans for improving heat dissipation from the fins of one or more heat sinks. In some embodiments, the active cooling system can also include a water sprayer for spraying water over parts and/or subcomponents of the separation device 134.

As described above, the separation device 134 can remove the residual fibers and other suspended materials form the hot BL feed 100; producing a hot conditioned feed 101. The hot conditioned feed 101 can be directed to the heat exchanger 132 to be cooled to the predetermined temperature prior to being directed to the filtration module 140. The heat exchanger 132 may be any suitable heat exchanger configured to cool the hot conditioned feed 101 by transferring heat from the hot conditioned feed 101 to a working fluid. In some implementations, the heat exchanger 132 can be a convection/conduction heat exchanger (e.g., the heat exchanger 132 utilizes the transfer of thermal energy from a surface by way of the motion of a cooling fluid relative to the surface of an enclosure containing the hot conditioned feed 101). Herein, it is important to note that the term “hot BL feed 100” indicates that the BL feed 100 entering the separation device 134 is at a higher temperature than the “hot conditioned feed 101” that enters the heat exchanger 132. Similarly, the term “hot conditioned feed 101” indicates that the conditioned feed 101 entering the heat exchanger 132 is at a higher temperature than the cold conditioned feed 101 leaving the heat exchanger. During the heat exchange, the hot conditioned feed 101 may be cooled by about a few tens of degrees. In an example embodiment, the hot conditioned feed 101 may be cooled by at least about 10 degrees Celsius (10° C.) and by no more than about 40° C.

In some embodiments, the feed preparation component 130 can include a heat exchanger that can be used to adjust the conditioned feed 101 to a predetermined temperature. In some embodiments the predetermined temperature of the conditioned feed 101 can be at least about 60° C., at least about 65° C., at least about 70° C., at least about 75° C., at least about 80° C., at least about 85° C., at least about 90° C., or at least about 95° C., inclusive of all values and ranges therebetween. In some embodiments the predetermined temperature of the conditioned feed 101 can be less than about 96° C., less than about 92° C., less than about 88° C., less than about 84° C., less than about 80° C., less than about 76° C., less than about 72° C., less than about 68° C., or less than about 64° C. less than about 60° C., inclusive of all values and ranges therebetween.

Combinations of the above referenced ranges for the predetermined temperature of the conditioned feed 101 are also possible (e.g., at least about 60° C. to less than about 90° C. or at least about 68° C. to less than about 80° C.).

Additional details of the integration of a heat exchanger with a feed treatment and/or separation device 134 are described in the disclosure of International Patent Application Number PCT/US2022/080120 entitled, “Heat Exchanger Integration with Membrane System for Evaporator Pre-concentration,” filed Nov. 18, 2022 (“the '120 application”), which is incorporated herein by reference. Alternatively, in some embodiments (not shown) the feed preparation component 130 can include a heat exchanger disposed downstream from the one or more feed treatment and/or a separation devices, with the heat exchanger being configured to adjust the temperature of the conditioned feed 101 prior to directing the conditioned feed 101 to the filtration module 140.

The filtration module 140 can be any suitable filtration apparatus fluidically coupled to the feed preparation component 130 and configured to receive the conditioned feed 101 at the predetermined temperature and produce a concentrate 102 and a permeate 103. Optionally, in some embodiments, the filtration module 140 can include a storage component 141 that can be used to accommodate and/or store the conditioned feed 101 for a period of time, prior to its processing. The storage component 141 can include and/or be one or more tanks having any suitable shape, dimensions, and/or capacity. The storage component 141 can include one or more valves, inlets, or ports (not shown) configured to allow a flow of liquid into or out of the tanks of the storage component 141 (e.g., to at least partially fill one or more tanks, collect samples for quality control purposes, and/or the like).

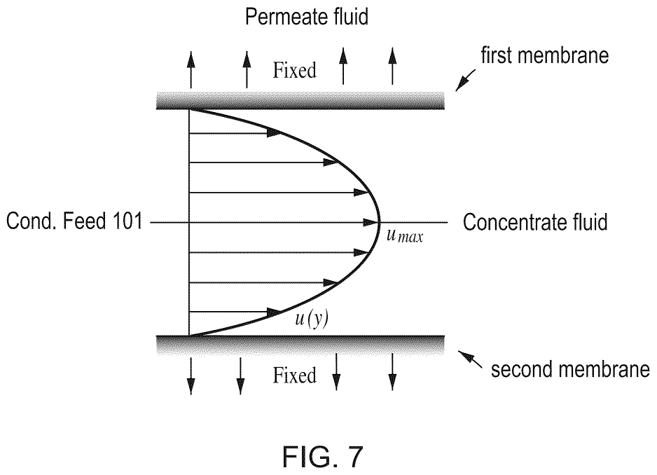

The filtration module 140, which can also be referred to herein as the “filtration component 140” or the “first filtration module, pass, and/or component” of the processing system 1000, is disposed downstream from the feed preparation component 130, as shown in FIG. 1. The filtration module 140 includes one or more graphene oxide membrane(s). The graphene oxide membrane(s) can be disposed on the filtration module 140 according to one or more configurations. For example, in some embodiments the filtration module 140 can include two or more graphene oxide membranes disposed parallel to each other, as shown schematically in FIG. 7. The filtration module 140 can receive the conditioned feed 101 at the predetermined temperature, and then flow, direct, and/or contact the conditioned feed 101 with the graphene oxide membrane(s) included in the filtration module 140. Selected species included in the conditioned feed 101 may be allowed to diffuse across the graphene oxide membrane(s) to produce a permeate fluid such as the permeate 103. Other species present on the conditioned feed 101 may be rejected by the graphene oxide membrane(s) (e.g., being prevented from diffusing across the graphene oxide membrane(s)) and thus produce a concentrate fluid such as the concentrate 102.

In some embodiments, the graphene oxide membrane can be disposed on a support substrate configured to provide mechanical stability to the graphene oxide membrane. The support substrate can comprise a plurality of flat polymer sheets combined to form a spiral filtration configuration. For example, in some embodiments, a spiral filtration configuration and/or module can comprise a plurality of flat polymer sheets stacked atop one another. The plurality of stacked flat polymer sheets may be rolled around a core tube. In some embodiments, prior to being rolled around the core tube, adjacent flat polymer sheets may be separated by a sheet of feed channel spacer to form a leaf, and each leaf may be separated by a sheet of permeate spacer. When the flat polymer sheets, the one or more feed channel spacers, and the one or more permeate spacers are rolled around the core tube, each permeate spacer may form a permeate channel. In such embodiments, the support substrate can include a material selected from polypropylene, polystyrene, polyethylene, polyethylene oxide, polyethersulfone, polytetrafluoroethylene, polyvinylidene fluoride, polymethylmethacrylate, polydimethylsiloxane, polyester, cellulose, cellulose acetate, cellulose nitrate, polyacrylonitrile, glass fiber, quartz, alumina, silver, polycarbonate, nylon, Kevlar or other aramid, or polyether ether ketone. In some embodiments, the support substrate can be and/or include any suitable membrane such as, for example, an ultrafiltration (UF) membrane, a nanofiltration (NF) membrane, and/or a reverse osmosis (RO) membrane.

In some embodiments, the filtration module 140 can process the conditioned feed 101 in multiple stages as needed, with concentrates from each stage being fed to a subsequent stage(s). For example, as shown in FIG. 1, in some embodiments the filtration module 140 can include a primary stage 142 and one or more optional auxiliary stages 143 fluidically coupled to the primary stage 142 and disposed in series downstream from the primary stage 142. The primary stage 142 and the auxiliary stage(s) 143 can each include and/or accommodate one or more graphene oxide membrane(s) disposed according to any suitable configuration, including, for example, the parallel configuration shown in FIG. 7. The primary stage 142 can receive the conditioned feed 101, and then flow, direct, and/or contact the conditioned feed 101 with the graphene oxide membranes to produce a primary concentrate and a primary permeate. The primary concentrate produced by the primary stage 142 can be directly fed to the auxiliary stage(s) 143 disposed downstream. The auxiliary stage(s) 143 can receive the primary concentrate and generate the concentrate 102 and an auxiliary permeate. The primary and auxiliary permeates produced in the primary stage 142 and in the secondary stage 143, respectively, can be combined to produce the permeate 103 shown in FIG. 1.

In some embodiments, the primary stage 142 and the auxiliary stage 143 can each be configured to recirculate a portion and/or a fraction of the concentrate produce in each stage, as shown in FIG. 1. To achieve this, each stage can be fitted with recirculation pumps (not shown), to enable achieving higher recovery rates and lower the energy consumption of the processing system 1000. More specifically, the recirculation of a portion of the concentrate produced in a stage to the feed the stage allows for the earlier stages (e.g., the primary stage 142 and those auxiliary stages 143 disposed downstream close to the primary stage 142) to operate at lower solids than the final auxiliary stage 143 (e.g., the auxiliary stage 143 disposed further downstream from the primary stage 142). This improves flux by lowering the osmotic pressure of the conditioning feed 101 and prevents membrane fouling.

The graphene oxide membranes included in the filtration module 140 can be similar to and/or the same as the graphene oxide membranes disclosed in U.S. Pat. No. 11,097,227, titled, “Durable Graphene Oxide Membranes,” issued Aug. 24, 2021 (“the '864 patent”); International Patent Application Number PCT/US2022/078051 entitled, “Filtration Apparatus Containing Alkylated Graphene Oxide Membrane,” filed Oct. 13, 2022 (“the '051 application”); and U.S. Pat. No. 11,123,694, titled, “Filtration Apparatus Containing Graphene Oxide membrane,” issued Sep. 21, 2021 (“the '694 patent”), which are incorporated herein by reference.

It is important to note the integration of graphene oxide membranes in the filtration module 140 enables and/or facilitates processing black liquor (e.g., the conditioned feed 101) at a temperature between about 60-90° C. and elevated pH (e.g., 11 to 13) to produce and/or generate (1) a concentrate 102 that contains primarily organic species such as lignin and hemicellulose, and (2) a permeate 103 that contains primarily monovalent and divalent inorganic salts, as well as small quantities of organic species. The ability to operate at such high temperatures stems from the thermal stability of graphene oxide membranes as well as their chemical stability under harsh alkaline conditions (e.g., pH=11-13). The integration of graphene oxide membranes to the processing system 1000 provides an approach to concentrating black liquor streams using pressure driven membranes, separating in a first filtration module (e.g., the filtration module 140) the majority of the large organic species present in the black liquor. This is result cannot be achieved using the conventional (RO) membranes disclosed in the prior art.

As described above, the graphene oxide membranes included in the filtration module 140 allow processing the conditioned feed 101 at a temperature between about 60-90° C. to produce and/or generate a concentrate 102. The concentrate 102 contains primarily organic species such as lignin and hemicellulose. In some embodiments, the concentrate 102 can have a total concentration of solids of at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, or at least about 25 wt. %, inclusive of all values and ranges therebetween.

Combinations of the above referenced ranges for the total concentration of solids in the concentrate 102 are also possible (e.g., at least about 15 wt. % to less than about 25 wt. %, or at least about 13.5 wt. % to less than about 22 wt. %).

The graphene oxide membranes included in the filtration module 140 also allow separating the conditioned feed 101 at a temperature between about 60-90° C. to produce and/or generate a permeate 103 that contains primarily smaller divalent and monovalent salts including, for example, sodium hydroxide (NaOH) and sodium sulfate (Na₂SO₄). In some embodiments, the permeate 103 can have a total concentration of solids of no more than about 9.0 wt. %, no more than about 8.0 wt. %, no more than about 7.5 wt. %, no more than about 7.0 wt. %, no more than about 6.5 wt. %, no more than about 6.0 wt. %, no more than about 5.5 wt. %, no more than about 5.0 wt. %, no more than about 4.5 wt. %, no more than about 4.0 wt. %, no more than about 3.5 wt. %, no more than about 3.0 wt. %, or no more than about 2.5 wt. %, inclusive of all values and ranges therebetween.

Combinations of the above referenced ranges for the total concentration of solids in the permeate 103 are also possible (e.g., at least about 3.0 wt. % to less than about 7.0 wt. %, or at least about 3.5 wt. % to less than about 6.0 wt. %).

Unlike graphene oxide membranes, (RO) membranes are designed for processes such as desalination and wastewater treatment, which are typically performed at low temperatures close to and/or near room temperature (e.g., 25° C.). As a result, the materials used to fabricate the (RO) membrane, as well as other components used in (RO) membrane systems, are typically limited to a maximum temperature range of 35-45° C. Reducing the temperature of the black liquor using a heat exchanger such that a conventional (RO) membrane can be used to process black liquor has proven impractical, due to the associated operational expense, as well as the limited solubility of some species and/or components of the black liquor which can precipitate out of the black liquor solution. Precipitation of one or more species and/or components of the black liquor can increase the potential for membrane fouling, which in turn can lead to a decreases and/or degradation of the membrane's performance and durability.

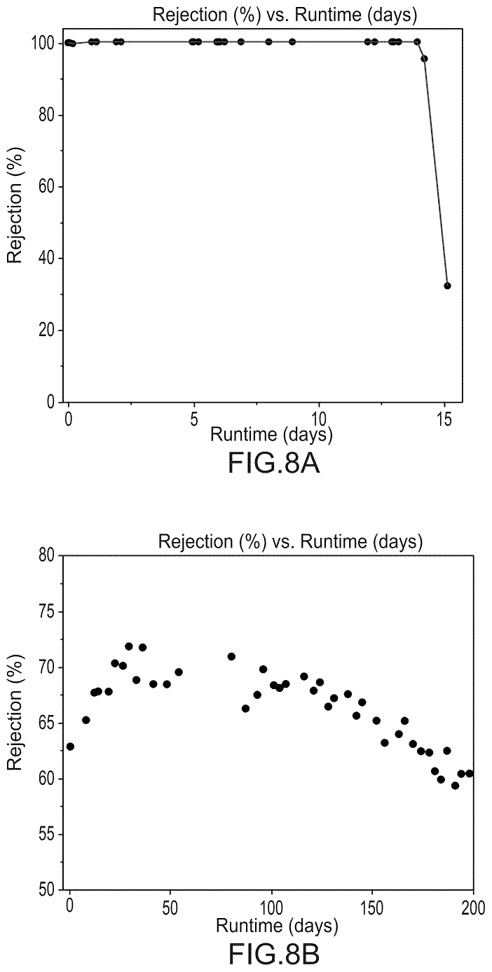

FIG. 8A shows is a plot of the total solids rejection rate as a function of time for filtration module comprising an (RO) membrane that operates in a black liquor solution at a temperature of 63° C. FIG. 8A shows that while the (RO) membrane exhibited an initial total solids rejection rate of about 100% at an operating pressure of about 500 psi, after approximately 14 days of operation the rejection rate suffered a sharp decline consistent with failure of at least one of the components in the filtration module and/or the (RO) membrane. For comparison, FIG. 8B shows a plot of the total solids rejection rate as a function of time for filtration module 140 comprising a graphene oxide membrane that operates at a temperature of 70° C. and a pressure of about 300 psi in a conditioned feed 101. FIG. 8B shows that the graphene oxide membrane maintains stable total solids rejection rate of at least 60% over a timespan of more than 200 days of continuous operation, demonstrating superior stability. The total solids rejection rate can be measured by conductivity (Cond) and/or refractive index (RI), with the total solids rejection rate being calculated as

$$rejection rate = \frac{1 - Permeate RI}{Feed RI} \times 100.$$

In some embodiments, the graphene oxide membrane(s) included in the filtration module 140 can exhibit a total solids rejection rate at an operating temperature of about 60-90° C. of at least about 45%, at least about 50%, at least about 55%, at least about 60%, at least about 65%, at least about 70%, at least about 75%, at least about 80%, at least about 85%, at least about 90%, or at least about 95%, inclusive of all values and ranges therebetween. In some embodiments, the graphene oxide membrane(s) included in the filtration module 140 can exhibit a total solids rejection rate of no more than about 94%, no more than about 88%, no more than about 84%, no more than about 80%, no more than about 76%, no more than about 72%, no more than about 68%, no more than about 64%, no more than about 60%, no more than about 56%, no more than about 52%, no more than about 48%, or no more than about 44%, inclusive of all values and ranges therebetween.

Combinations of the above referenced ranges for the total solids rejection rate of the graphene oxide membrane(s) are also possible (e.g., at least about 60% less than about 90% or at least about 68% to less than about 80%).

As described above, the integration of the graphene oxide membranes in the filtration module 140 enables and/or facilitates processing black liquor (e.g., the conditioned feed 101) at a temperature between about 60-90° C. to produce and/or generate a concentrate 102 that contains primarily organic species such as lignin and hemicellulose. The conditioned feed 101 can have a total concentration of solids in the range of approximately 4 to 18 wt. % prior being processed by the filtration module 140. The filtration module 140 can process the conditioned feed 101 and produce a concentrate 102 having total concentration of solids in the range of 15-25 wt. %. Conventional (RO) membranes are incapable of operating in this range of concentration of solids. The ultra-tight pores of (RO) membranes provide a barrier to even very small species, such as monovalent salts. As a result, the osmotic pressure, the minimum pressure that must be applied to achieve flow through the membrane, of a conditioned feed 101 being processed in the filtration module 140 exceeds the pressure ratings of both (RO) membranes and standard pressure vessels, (e.g., for example at least about 1200 psi or higher). In contrast, the graphene oxide membranes have a looser pore spacing that allows passage of monovalent and some divalent salts while retaining larger species such as lignin and hemicellulose. Consequently, the osmotic pressure of a conditioned feed 101 being processed in the filtration module 140 with the graphene oxide membrane is significantly decreased, allowing operation at moderate pressures, (e.g., at pressures equal to and/or lower than about 800 psi).

In some embodiments, the graphene oxide membrane(s) included in the filtration module 140 can experience an osmotic pressure of less than about 800 psi, less than about 500 psi, less than about 480 psi, less than about 460 psi, less than about 440 psi, less than about 420 psi, less than about 400 psi, less than about 380 psi, less than about 360 psi, less than about 320 psi, less than about 300 psi, less than about 280 psi, less than about 260 psi, less than about 220 psi, less than about 200 psi, less than about 180 psi, less than about 160 psi, less than about 140 psi, less than about 120 psi, less than about 100 psi, less than about 80 psi, less than about 70 psi, less than about 60 psi, or less than about 50 psi inclusive of all values and ranges therebetween. In some embodiments, the graphene oxide membrane(s) included in the filtration module 140 can experience an osmotic pressure of at least about 50 psi, at least about 75 psi, at least about 100 psi, at least about 125 psi, at least about 150 psi, at least about 175 psi, at least about 200 psi, at least about 250 psi, at least about 300 psi, at least about 350 psi, at least about 400 psi, at least about 450 psi, at least about 500 psi, at least about 600 psi, at least about 700 psi, or at least about 800 psi, inclusive of all values and ranges therebetween.

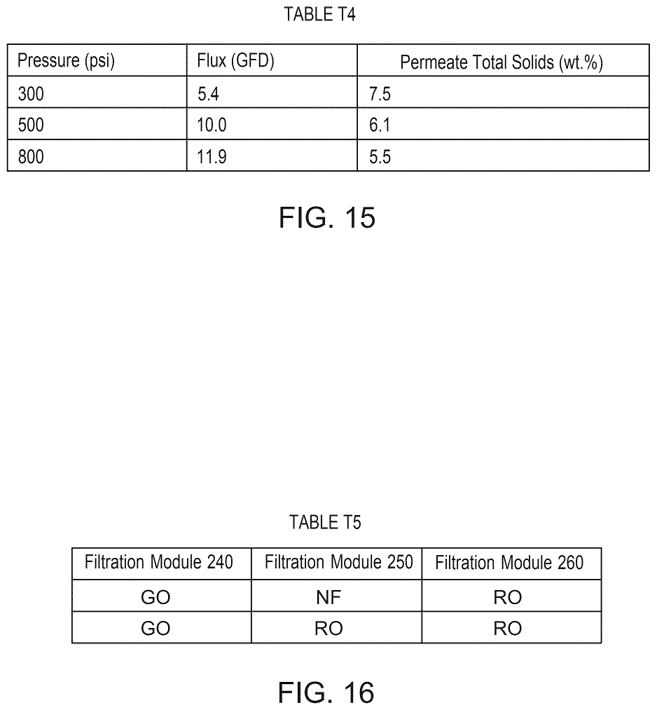

Combinations of the above referenced ranges for the osmotic pressure experienced by the graphene oxide membrane(s) are also possible (e.g., an osmotic pressure of about 200 psi to about 800 psi, about 250 psi and about 480 psi). It is worth noting that in some embodiments, the conditioned feed 101 can be directed and/or flowed to the filtration module 140 at a pumping pressure. In some embodiments, the osmotic pressure of the conditioned feed 101 in the filtration module 140 can be a percentage of the pumping pressure. For example, in some embodiments, the osmotic pressure of the conditioned feed 101 can about 50% or less, about 45% or less, about 40% or less, about 35% or less, or about 30% or less of the pumping pressure. The osmotic pressure is less than the pumping pressure to allow some overpressure to drive flux and transport. The selection of predetermined operating pressures can improve the flux of the graphene oxide membrane(s) and as well as increase the TDS obtained in the membrane's permeate stream. For example, FIG. 15 shows a table summarizing flux in (GFD) and permeate total dissolved solids (TDS, wt. %) of a graphene oxide membrane included in a filtration module 140 operating in a conditioned feed 101 at different operating pressures. The data included in FIG. 15 was recorded with a filtration module 140 that included a graphene oxide membrane disposed on a polyethersulfone (PES) ultrafiltration (UF) membrane serving as support substrate, operating at 70° C. in a conditioned feed 101 which was processed in a feed preparation component 130 that included tubular ceramic membranes having an average pore size of about 15 kDa. FIG. 15 shows increasing the pressure from 300 psi to 500 and 800 psi results in both increased flux and a lower permeate solids.

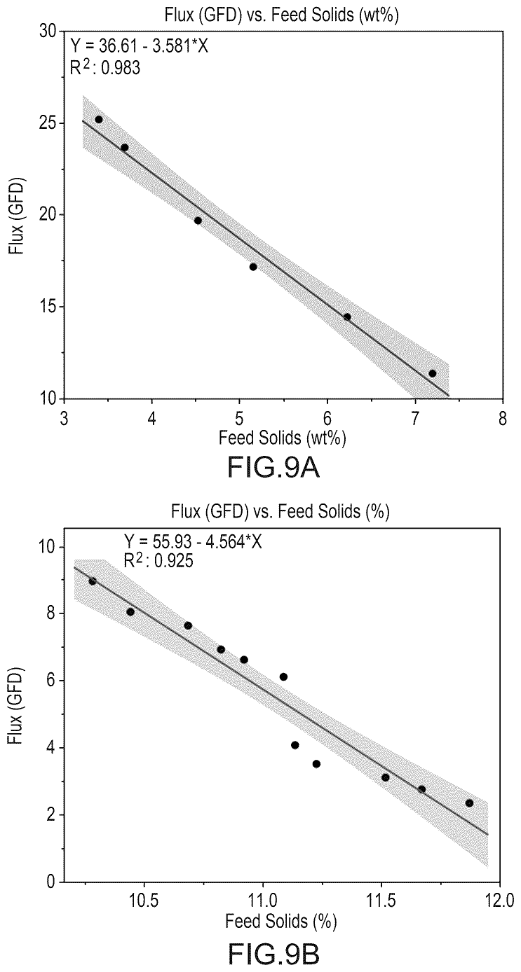

FIGS. 9A and 9B show plots of the flux in gallons per foot square days (GFD) of polymeric (RO) membranes as a function of total concentration of solids present in the feed. FIGS. 9A and 9B highlight the inability of the (RO) membranes to operate in solutions comprising high total concentration of solids dissolved such as the conditioned feed 101 and/or other black liquor streams due to low flux. FIG. 9A depicts the flux (in gallons per square foot per day, GFD) of a conventional (RO) membrane (e.g., a polyamide FilmTec™ SW30 membrane, DuPont) as a function of the total concentration of solids in the feed (in wt. %). The flux through the (RO) membrane decreases by more than 50% as the total concentration of solids in the feed is increased from about 3.4 wt. % to about 7.2 wt. %. Based on a linear fit, the flux of the (RO) membrane is predicted to reach zero at a total concentration of solids in the feed of approximately 10.2 wt. %, which is well below the required operating range required for the first filtration module 140.

Even (RO) membranes designed for higher solids operation fail to exhibit a suitable performance for processing the conditioned feed 101 and/or other black liquor streams. FIG. 9B depicts the flux (in GFD) of an (RO) membrane designed for operation in high concentration of solids (e.g., a polyamide FilmTec™ Fortilife™ XC120 membrane, DuPont) as a function of the total concentration of solids in the feed (in wt. %). The flux through this higher solids (RO) membrane declines sharply as the total concentration of solids in the feed is increased. Based on a linear fit, the flux through this higher solids (RO) membrane is predicted to reach zero at total concentration of solids in the feed of approximately 12.5 wt. %.

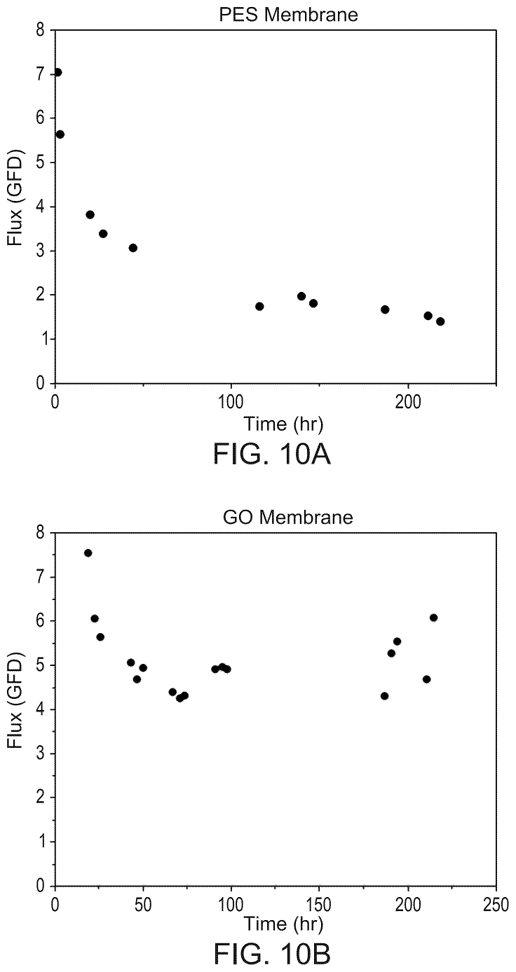

The use of ultrafiltration (UF) membranes for processing of Black Liquor has also proven unsuccessful. Despite the fact that (UF) membranes can have larger pore size than conventional (RO) membranes, and thus are not limited by osmotic potential, their use for processing black liquor streams such as the BL feed 100 is hindered due to fouling. Ultrafiltration membranes can be prone to fouling due to the high total concentration of solids and the variety of constituent species contained in the conditioned feed 101 and/or other black liquor streams. In some instances, species included in the conditioned feed 101 and/or other black liquor streams can interact with the UF membrane and cause irreversible fouling. FIG. 10A shows a plot of the flux as a function of time for an ultrafiltration (UF) polymeric membrane (e.g., a polyethersulfone (PES) membrane) having a molecular weight cutoff of about 10 kDa during operation in a black liquor feed similar to the conditioning feed 101. FIG. 10A reveals that within the first 100 hours of operation the membrane, the flux decreases from 7 GFD to less than 2 GFD due to fouling of the (RO) membrane. By contrast, FIG. 10B shows a plot of the flux as a function of time for a graphene oxide membrane included in a filtration module 140 during operation in a conditioning feed 101. The graphene oxide membrane exhibits superior flux stability when compared with the (UF) membrane shown in FIG. 10A. After an initial decline from about 7.5 GFD to about 5 GFD within the first 24 hours of operation, FIG. 10 B shows the flux of the graphene oxide membrane stabilizes over the remainder of the test. The stability of the flux observed with the graphene oxide membrane provides evidence of the resistance of the graphene oxide membrane to degradation due to fouling in the conditioned feed 101.

Turning back to FIG. 1, the processing system 1000 also includes a filtration module 150. The filtration module 150 can be any suitable filtration apparatus fluidically coupled to the filtration module 140 and configured to receive the permeate 103 and produce a concentrate 104 and a permeate 105. Optionally, in some embodiments, the filtration module 150 can include a storage component 151 that can be used to accommodate and/or store the permeate 103 for a period of time, prior to its processing. The storage component 151 can be similar to and/or the same as the storage component 141 described above with reference to the filtration module 140. Consequently, no further description of the storage component 151 will be provided herein.

The filtration module 150, which can also be referred to herein as the “filtration component 150” or the “second filtration module, pass, and/or component” of the processing system 1000, is disposed downstream from the filtration module 140, as shown in FIG. 1. The filtration module 150 can be similar to the filtration module 140 described above. As such, portions and/or aspects of the filtration module 150 can be similar to and/or substantially the same as portions and/or aspects of the filtration module 140, and therefore are not described in detail herein. The filtration module 150 can include one or more high total dissolved solids reverse osmosis (RO) membrane(s), one or more nanofiltration (NF) membranes, or a combination thereof. For example, in some embodiments the filtration module 150 can include one or more high total dissolved solids (RO) membranes such as a polyamide FilmTec™ Fortilife™ XC120 (DuPont) which can operate at a total concentration of dissolved solids of up to about 12 wt. %. In some embodiments, the filtration module 150 can include one or more (NF) membranes having a MWCO of about 0.1-1.0 kDa, and capable of operating at temperatures up to 50 or 60° C. at a pH of 0-14. For example, filtration module 150 can include one or more (NF) membranes such as a Kovalus (formerly Koch Separation Solutions) SelRO MPS-34, and/or a Unisol AMS NanoPro B-4021 membrane. The (RO) membrane(s) and/or the (NF) membranes can be disposed on the filtration module 150 according to one or more configurations. For example, in some embodiments the filtration module 150 can include two or more (RO) or (NF) membranes disposed parallel to each other, as shown schematically in FIG. 7. The filtration module 150 can receive the permeate 103 and then flow, direct, and/or contact the permeate 103 with the membranes. Selected species included in the permeate 103 (e.g., small size monovalent species such as NaOH and small amounts of divalent salts) may be allowed to diffuse across the membrane(s) to produce a permeate 105. Other species present on the permeate 103 (e.g., the remaining organic species that managed to diffuse across the graphene oxide membrane of the filtration module 140, divalent salts such as Na₂SO₄, and some monovalent salts) may be rejected by the membrane(s) and thus produce the concentrate 104.

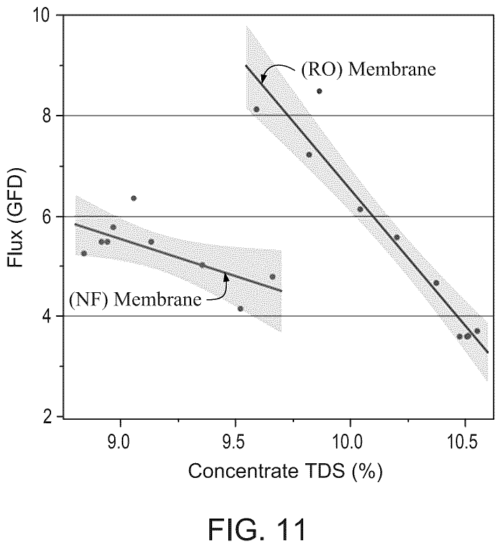

FIG. 11 shows a plot of flux in gallons per foot square day (GFD) of a nanofiltration (NF) membrane (Unisol B-4021) and a reverse osmosis (RO) membrane (FilmTec XC120) as a function concentrate TDS (e.g., the TDS of a concentrate stream produced by the membrane). FIG. 11 shows the (NF) and (RO) membranes exhibit an expected decrease and/or reduction in flux as the concentrate TDS is increased from 8.5% to about 10.5%. Comparison of the rate of flux reduction for the (NF) and (RO) membranes (e.g., the slope of the (RO) and (NF) curves in FIG. 11) indicates that the (NF) membrane can be operated at higher concentrate TDS without sacrificing and/or losing as much flux as the (RO) membrane. Consequently, in some embodiments the filtration module 150 can include one or more (NF) membranes such as those described above.

In some embodiments, the filtration module 150 can process the permeate 103 in multiple stages as needed, with concentrates from each stage being fed to a subsequent stage(s). For example, as shown in FIG. 1, in some embodiments the filtration module 150 can include a primary stage 152 and one or more optional auxiliary stages 153 fluidically coupled to the primary stage 152 and disposed in series downstream from the primary stage 152. The primary stage 152 and the auxiliary stage(s) 153 can each include and/or accommodate one or more RO or NF membrane disposed according to any suitable configuration, including, for example, the parallel configuration shown in FIG. 7. The primary stage 152 can receive the permeate 103, and then flow, direct, and/or contact the permeate 103 with the (RO) or (NF) membranes to produce a primary concentrate and a primary permeate. The primary concentrate produced by the primary stage 152 can be directly fed to the auxiliary stage(s) 153 disposed downstream. The auxiliary stage(s) 153 can receive the primary concentrate and generate the concentrate 104 and an auxiliary permeate. The primary and the auxiliary permeate produced in the primary stage 142 and in the secondary stage 143, respectively, can be combined to produce the permeate 105 shown in FIG. 1.

As described above with respect to the primary stage 142 and the auxiliary stage 143, the primary stage 152 and the auxiliary stage 153 can each be configured to recirculate a portion and/or a fraction of the concentrate produce in each stage, as shown in FIG. 1. To achieve this, each stage can be fitted with recirculation pumps (not shown), to enable achieving higher recovery rates and lower the energy consumption of the processing system 1000.

The RO or NF membrane(s) in the filtration module 150 enable processing the permeate 103 to produce and/or generate (1) a concentrate 104 that contains primarily the remaining organic species, divalent salts such as sodium sulfate (Na₂SO₄) and some monovalent salts; and (2) a permeate 105 that contains primarily monovalent salts such as sodium hydroxide (NaOH) and small amounts of divalent salts. It is worth noting that because the graphene oxide membrane(s) in the filtration module 140 produces a permeate 103 with a lower level of solids and a much smaller flowrate than the level of solids and the flow rate observed with the conditioned feed 101, in some embodiments the permeate 103 can be cooled (without producing precipitation and/or fouling of the membrane) and then passed to the RO or NF membrane(s) in the filtration module 150 for removal of the remaining constituents of the conditioned feed 101. To cool the permeate 103 prior to entering the filtration module 150, the processing system 1000 may include one or more heat exchangers (not shown in FIG. 1) disposed between the filtration module 140 and 150 (e.g., one or more heat exchangers disposed downstream of the filtration module 140 and upstream the filtration module 150). These heat exchangers can be configured to receive the permeate 103 and cool and/or adjust the temperature of the permeate 103 to a suitable operating temperature for the filtration membranes included in the filtration module 150. For example, in some embodiments the permeate 103 can be cooled in a heat exchanger prior to entering the filtration module 150 such that the RO or NF membrane(s) in the filtration module 150 can operate at a temperature as high as about 50° C., as high as about 46° C., as high as about 42° C., as high as about 38° C., or as high as about 35° C., inclusive of all values and ranges therebetween.

As described above, in some embodiments the RO or NF membrane(s) included in the filtration module 150 allow processing the permeate 103 at temperature as high as about 50° C. to produce and/or generate the permeate 105. The permeate 105 contains primarily monovalent salts such as sodium hydroxide (NaOH) and small amounts of divalent salt. In some embodiments, the permeate 105 can have a total concentration of solids of no more than about 2.5 wt. %, no more than about 2.0 wt. %, no more than about 1.5 wt. %, no more than about 1.0 wt. %, or no more than about 0.5 wt. %, inclusive of all values and ranges therebetween.

Combinations of the above referenced ranges for the total concentration of solids in the permeate 105 are also possible (e.g., at least about 1.0 wt. % to less than about 5.0 wt. %, or at least about 3.5 wt. % to less than about 4.0 wt. %).

In some embodiments, the RO or NF membrane(s) included in the filtration module 150 can operate at a pressure (e.g., a pumping pressure) of less than about 1100 psi, less than about 1050 psi, less than about 1000 psi, less than about 950 psi, less than about 900 psi, less than about 850 psi, less than about 800 psi, less than about 750 psi, or less than about 700 psi, inclusive of all values and ranges therebetween. In some embodiments, the RO or NF membrane(s) included in the filtration module 150 can operate at a pressure (e.g., a pumping pressure) of at least about 700 psi, at least about 800 psi, at least about 900 psi, at least about 1000 psi, or at least about 1100 psi, inclusive of all values and ranges therebetween.

Combinations of the above referenced ranges for the operating pressure of the RO or NF membrane(s) in the filtration module 150 are also possible (e.g., a pressure of about 700 psi to about 1100 psi, about 850 psi and about 1050 psi).

FIG. 1 shows the processing system 1000 also includes a filtration module 160. The filtration module 160 can be any suitable filtration apparatus fluidically coupled to the filtration module 150 and configured to receive the permeate 105 and produce a concentrate 106 and a permeate 107. Optionally, in some embodiments, the filtration module 160 can include a storage component 161 that can be used to accommodate and/or store the permeate 105 for a period of time, prior to its processing. The storage component 161 can be similar to and/or the same as the storage component 141, and 151 described above with reference to the filtration modules 140 and 150. Consequently, no further description of the storage component 161 will be provided herein.

The filtration module 160, which can also be referred to herein as the “filtration component 160” or the “third filtration module, pass, and/or component” of the processing system 1000, is disposed downstream from the filtration module 150, as shown in FIG. 1. The filtration module 160 can be similar to the filtration modules 140 and/or 150 described above. As such, portions and/or aspects of the filtration module 160 can be similar to and/or substantially the same as portions and/or aspects of the filtration module 140 and 150, and therefore are not described in detail herein. The filtration module 160 includes one or more (RO) membrane(s), preferably those with high rejection of monovalent salts. For example, in some embodiments, the filtration module 160 can include a (RO) membrane such as a polyamide FilmTec™ SW30 membrane (DuPont)

The (RO) membrane(s) can be disposed on the filtration module 160 according to one or more configurations. For example, in some embodiments the filtration module 160 can include two or more (RO) membranes disposed parallel to each other, as shown schematically in FIG. 7. The filtration module 160 can receive the permeate 105 and then flow, direct, and/or contact the permeate 105 with the (RO) membranes. Selected species included in the permeate 105 (e.g., small size monovalent salts and NaOH) may be allowed to diffuse across the (RO) membrane(s) to produce a permeate 107. Other species present on the permeate 105 may be rejected by the (RO) membrane(s) (e.g., some monovalent salts and remaining divalent salts) and thus produce the concentrate 106.

In some embodiments, the (RO) membrane(s) in the filtration module 160 can operate at a temperature as high as about 50° C., as high as about 46° C., as high as about 42° C., as high as about 38° C., or as high as about 35° C., inclusive of all values and ranges therebetween.

As described above, in some embodiments the (RO) membrane(s) included in the filtration module 160 allow processing the permeate 105 at a temperature as high as about 50° C. to produce and/or generate the permeate 107. The permeate 107 contains primarily small amounts of monovalent salts and NaOH. In some embodiments, the permeate 107 can have a total concentration of solids of no more than about 0.5 wt. %, no more than about 0.4 wt. %, no more than about 0.3 wt. %, no more than about 0.2 wt. %, no more than about 0.1 wt. %, no more than about 0.09 wt. %, no more than about 0.08 wt. %, no more than about 0.07 wt. %, no more than about 0.06 wt. %, or no more than about 0.05 wt. %, inclusive of all values and ranges therebetween.

Combinations of the above referenced ranges for the total concentration of solids in the permeate 107 are also possible (e.g., at least about 1.0 wt. % to less than about 0.4 wt. %, or at least about 0.5 wt. % to less than about 0.7 wt. %).

The (RO) membrane(s) included in the filtration module 160 can operate at pressures similar to the pressures disclosed above with respect to the (RO) membrane(s) included in the filtration module 150. That is, in some embodiments, the (RO) membrane(s) included in the filtration module 160 can operate at a pressure (e.g., a pumping pressure) of less than about 1100 psi, less than about 1050 psi, less than about 1000 psi, less than about 950 psi, less than about 900 psi, less than about 850 psi, less than about 800 psi, less than about 750 psi, or less than about 700 psi, inclusive of all values and ranges therebetween. In some embodiments, the (RO) membrane(s) included in the filtration module 160 can operate at a pressure (e.g., a pumping pressure) of at least about 700 psi, at least about 800 psi, at least about 900 psi, at least about 1000 psi, or at least about 1100 psi, inclusive of all values and ranges therebetween.

Combinations of the above referenced ranges for the operating pressure of the (RO) membrane(s) in the filtration module 160 are also possible (e.g., a pressure of about 700 psi to about 1100 psi, about 850 psi and about 1050 psi).

In some embodiments, the permeate 107 can be returned to the mill for re-use in applications such as pulp washing. Alternatively, in other embodiments in which further treatment may be required (e.g., a further reduction of permeate conductivity), the permeate 107 can be directed to the filtration module 170, as shown in FIG. 1. The filtration module 170, which can also be referred to herein as the “filtration component 170” or the “fourth filtration module, pass, and/or component” of the processing system 1000, is disposed downstream from the filtration module 160, as shown in FIG. 1. The filtration module 170 can be similar to the filtration modules 140, 150, and/or 160 described above. As such, portions and/or aspects of the filtration module 170 can be similar to and/or substantially the same as portions and/or aspects of the filtration module 140, 150 and 160, and therefore are not described in detail herein. The filtration module 170 includes one or more (RO) membrane(s) similar to those used in the filtration module 160. For example, in some embodiments, the filtration module 170 can include a (RO) membrane such as a polyamide FilmTec™ SW30 membrane (DuPont).

The (RO) membrane(s) can be disposed on the filtration module 170 according to one or more configurations. For example, in some embodiments the filtration module 170 can include two or more (RO) membranes disposed parallel to each other, as shown schematically in FIG. 7. The filtration module 170 can receive the permeate 107 and then flow, direct, and/or contact the permeate 107 with the (RO) membranes. Selected species included in the permeate 107 (e.g., trace amounts of monovalent salts, similar in quantity to those found in evaporator condensate obtained when processing black liquor with existing thermal evaporators) may be allowed to diffuse across the (RO) membrane(s) to produce a process permeate 120. Other species present on the permeate 107 may be rejected by the (RO) membrane(s) (e.g., monovalent salts) and thus produce the concentrate 108. The processed permeate 120 can be sent and/or returned to the mill for re-use in applications such as pulp washing.

In some embodiments, the concentrate 102, 104, and 106 can combined into a processed concentrate 110, characterized by a higher total concentration of solids with respect the BL feed 100. In some instances, the processed concentrate 110 can be sent and/or fed to an evaporator of the mill for further concentration. In some embodiments, the concentrate 108 can optionally be returned as a feed to the filtration module 160, as depicted in FIG. 1.

Alternatively, in other embodiments, the concentrate 108 can be combined with the concentrates 102, 104, and 106, to produce the processed concentrate 110. In some embodiments, the processed concentrate 110 and the processed permeate 120 can be fed back to the heat exchanger included in the feed preparation component 130 to adjust the temperature of the BL feed 100.

In some embodiments, the (RO) membrane(s) in the filtration module 170 can operate at a temperature as high as about 50° C., as high as about 46° C., as high as about 42° C., as high as about 38° C., or as high as about 35° C., inclusive of all values and ranges therebetween.

As described above, in some embodiments the (RO) membrane(s) included in the filtration module 170 allow processing the permeate 107 at a temperature as high as about 50° C. to produce and/or generate the processed permeate 120. The processed permeate 120 consists of trace amounts of monovalent salts, similar in quantity to those found in evaporator condensate obtained when processing black liquor with existing thermal evaporators. In some embodiments, the processed permeate 120 can have a total concentration of solids of no more than about 0.1 wt. %, no more than about 0.09 wt. %, no more than about 0.08 wt. %, no more than about 0.07 wt. %, no more than about 0.06 wt. %, no more than about 0.05 wt. %, no more than about 0.04 wt. %, no more than about 0.03 wt. %, no more than about 0.02 wt. %, no more than about 0.01 wt. %, no more than about 0.009 wt. %, no more than about 0.008 wt. %, no more than about 0.007, no more than about 0.006, no more than about 0.005, no more than about 0.004, no more than about 0.003, no more than about 0.002, or no more than about 0.001 wt. %, inclusive of all values and ranges therebetween.

Combinations of the above referenced ranges for the total concentration of solids in the processed permeate 120 are also possible (e.g., at least about 0.1 wt. % to less than about 0.01 wt. %, or at least about 0.08 wt. % to less than about 0.05 wt. %).

In some embodiments, the (RO) membrane(s) included in the filtration module 170 can operate at a pressure (e.g., a pumping pressure) of less than about 500 psi, less than about 450 psi, less than about 400 psi, less than about 350 psi, less than about 300 psi, less than about 250 psi, or less than about 200 psi, inclusive of all values and ranges therebetween. In some embodiments, the (RO) membrane(s) included in the filtration module 160 can operate at a pressure (e.g., a pumping pressure) of at least about 200 psi, at least about 300 psi, at least about 400 psi, or at least about 500 psi, inclusive of all values and ranges therebetween.

Combinations of the above referenced ranges for the operating pressure of the (RO) membrane(s) in the filtration module 170 are also possible (e.g., a pressure of about 200 psi to about 500 psi, about 280 psi and about 450 psi).

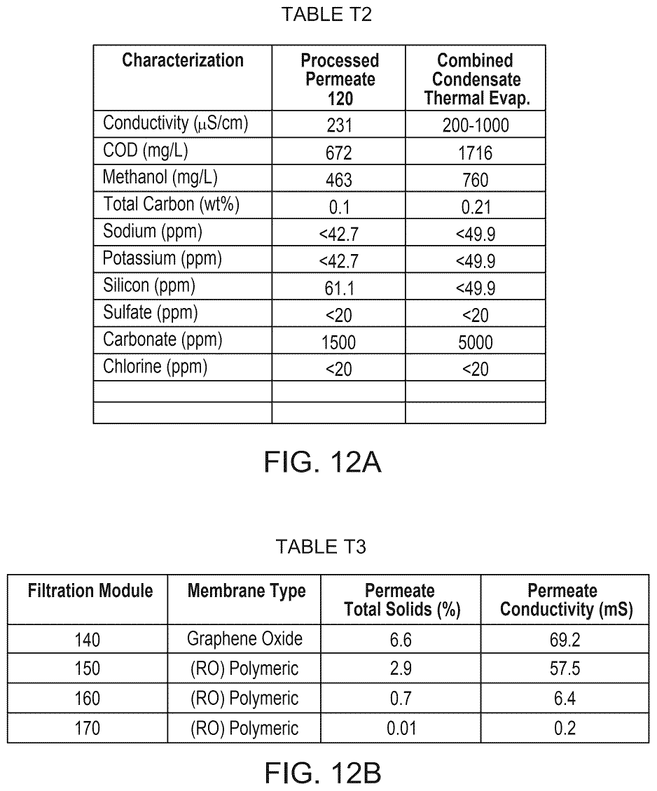

FIG. 12A shows table depicting a comparison of the concentration of species of a processed permeate and a combined condensate from an evaporator system. FIG. 12A shows processing of black liquor streams such as the BL feed 100 can be achieved using a pressure driven separation system such as the processing system 1000. The processing system 1000 can produce streams such as the processed permeate 120 which have chemical composition similar to that obtained by the thermal evaporators disclosed in the prior art, avoiding the need for a liquid to vapor phase transition required in thermal evaporators, and thus enabling costs savings to a mill through reductions in energy usage and/or consumption. FIG. 12B provides a summary of the total concentration of solids in the permeate streams produces during operation of the processing system 1000, providing evidence of the removal of large amounts of species included in the black liquor, enabling recirculation of water in the mill.

FIG. 13 a schematic illustration of an example system 2000 for the processing of a black liquor feed, according to an embodiment. The system 2000, which can also be referred here as the “black liquor processing system 2000” or the processing system 2000″ can be configured to receive a black liquor (BL) feed 200 and process it to produce a processed concentrate 210 and a processed permeate 220 with a set of desired and/or target characteristics such as a target conductivity and/or a target TDS. The system 2000 includes a feed preparation component 230, a filtration module and/or component 240, and a filtration module and/or component 250. Optionally, in some embodiments the system 2000 can also include a filtration module and/or component 260, and a storage component 241, 251, and 261 coupled to the filtration module 240, 250, and 260, respectively. FIG. 13 shows in some embodiments the processing system 2000 can produce a processed permeate 220 with a reduced number of filtration passes and/or modules (e.g., filtration modules 240 and 250) compared to the processing system 1000 described above with reference to FIG. 1 which includes 4 filtration passes and/or modules (e.g., filtration modules 140, 150, 160 and 170). In such embodiments, the processing system 2000 can be designed to operate under different process conditions compared to the processing system 1000. For example, the processing system 2000 can be designed to operate with a BL feed 200 that has a different composition (e.g., lower total concentration of solids) compared to the BL feed 100. The BL feed 200 can be obtained and/or procured, for example, from the washer portion of a mill. The BL feed 200 obtained from the washer portion of the mill can have a total concentration of solids that is lower than the typical 10-20 wt. % described above with reference to the BL feed 100. For example, in some embodiments, the BL feed 200 can be any suitable black liquor stream produced in a mill having a total concentration of solids (TDS) in the range of approximately 1 to 9 wt. %. In some embodiments, the processing system 2000 can be designed to produce a processed permeate 220 characterized by a set of desired and/or target characteristics different from those of the processed permeate 120 described above with reference to the processing system 1000. For example, the processing system 2000 can be designed to produce a processed permeate 220 that contains primarily monovalent salts such as sodium hydroxide (NaOH), and small amounts of divalent salts. In some embodiments, the processed permeate 220 can have a total concentration of solids of no more than about 4.0 wt. %, no more than about 3.5 wt. %, no more than about 3.0 wt. %, no more than about 2.5 wt. %, no more than about 2.0 wt. %, no more than about 1.5 wt. %, no more than about 1.0 wt. %, no more than about 0.9 wt. %, no more than about 0.8 wt. %, no more than about 0.7 wt. %, no more than about 0.6 wt. %, no more than about 0.5 wt. %, no more than about 0.4 wt. %, no more than about 0.3 wt. %, no more than about 0.2 wt. %, or no more than about 0.1 wt. %, inclusive of all values and ranges therebetween. In some embodiments, the processing system 2000 can be designed such that the filtration modules 240 and 250 produce a permeate (e.g., a permeate 203 and 220) with a set of desired and/or target characteristics defined by their color instead of their conductivity, as in the processing system 1000. For example, in some embodiments the processing system 2000 can be designed to produce one or more permeate streams that are visibly clear when view through a container of predetermined size (e.g., a 1-20 mL vial). As shown in FIG. 13, in some embodiments the processing system 2000 can include an optional filtration pass and/or module 260. In such embodiments, the processing system 2000 can be designed to operate in a BL feed 200 similar to and or the same as the BL feed 100 (e.g., a BL feed with a total concentration of solids in the range of 10 to 20 wt. %) and produce a processed permeate 220 having similar and/or the same characteristics as that of the processed permeate 120 described above with reference to FIG. 1. More specifically, in those embodiments the processing system 2000 can include a feed preparation component 230 that includes one or more ceramic membranes having a relatively small pore size separating media (e.g., about 1 kDa to about 10 μm), as described above with reference to the feed preparation component 130. The ceramic membranes can be any suitable shape/form (e.g., tubular and/or planar or flat sheet), and include single-channel and/or multi-channel geometry. The feed preparation component 230 produce a conditioned feed 201 which can be further processed by the filtration passes and/or modules 240, 250 and 260 to produce the processed concentrate 210 and the processed permeate 220. In some embodiments, the processing system 2000 can be designed to operate such that one or more concentrate stream produced in the filtration modules 240, 250 and 260 is not combined to produce a processed concentrate 210 as shown in FIG. 13. For example, in some embodiments the processing system 2000 can be configured to divert concentrate 204 and concentrate 206 produced in the filtration modules 250 and 260 respectively, to a different process, and produce the processed concentrate 210 directly from the filtration module 240 (e.g., from concentrate 202).

Turning back to FIG. 13, the feed preparation component 230 can be similar to the feed preparation component 130 described above with reference to the system 1000. As such, portions and/or aspects of the feed preparation component 230 that are similar to and/or substantially the same as portions and/or aspects of the feed preparation component 130 are not described in detail herein. The feed preparation component 230 can receive a black liquor (BL) feed 200, conduct one or more preparation and/or conditioning steps, and produce a conditioned (Cond) feed 201. In some embodiments the BL feed 200 can be any suitable black liquor stream produced in a mill having a total concentration of solids in the range of approximately 10 to 20 wt. %. Alternatively, in some embodiments the BL feed 200 can be any suitable black liquor stream produced in a mill having a total concentration of solids in the range of approximately 1 to 9 wt. %. The feed preparation component 230 can remove materials suspended on the BL feed 200 including residual fibers produced during the pulping process, and/or a portion (or all) of the large size organic species dissolved in the BL feed 200. For example, in some embodiments, the feed preparation component 230 can be configured to remove a majority of the residual fibers and other suspended materials present in the BL feed 200. In other embodiments, the feed preparation component 230 can be configured to remove a majority of the residual fibers and other suspended materials, as well as a portion of the large size organic species dissolved in the BL feed 200 (e.g., the hemicellulose, cellulose, lignin, and the like). In some embodiments, the feed preparation component 230 can be configured to remove a percentage of the large size organic species dissolved in the BL feed 100, including, for example, about 10%, about 15%, about 20%, about 30%, about 40%, about 50%, about 60%, about 70%, about 80%, about 90%, or about 100%, inclusive of all values and ranges therebetween. In some embodiments, the feed preparation component 230 can include one or more heat exchangers (not shown in FIG. 13) that can be used to adjust the conditioned feed 201 to a predetermined temperature. The conditioned feed 201 can then be directed and/or flown to the filtration module 240 at the predetermined temperature for further processing until generating a processed concentrate 210 and a processed permeate 220, as further described herein. Optionally, in some embodiments, the conditioned feed 201 can be stored in a storage compartment 241 prior to being directed to the filtration module 240.

The feed preparation component 230 includes one or more tubular ceramic membranes having a single-channel and/or multi-channel geometry and comprising a separating media having an average pore size of about 1 kDa to about 10 μm. The tubular ceramic membranes can be configured to have an average pore size smaller than the average size of the fibers and other materials suspended on the BL feed 200, such that the tubular ceramic membranes prevent passage of those materials (e.g., the tubular ceramic membranes reject the residual fibers and other materials suspended materials). Additionally, the average pore size of the tubular ceramic membranes can also facilitate removing and/or rejecting a portion of the large size dissolved organic species (e.g., the hemicellulose, cellulose, lignin, and the like). For example, in some embodiments the tubular ceramic membranes can remove and/or reject a percentage of the large size organic species dissolved in the BL feed 200 of about 10%, about 15%, about 20%, about 30%, about 40%, about 50%, about 60%, about 70%, about 80%, about 90%, or about 100%, inclusive of all values and ranges therebetween.

The feed preparation component 230 can receive the BL feed 200 and produce a conditioned (Cond.) feed 201 having a predetermined temperature and predetermined TDS. For example, in some embodiments, the feed preparation component 230 can produce a conditioned feed 201 having a predetermined temperature and a predetermined and/or target TDS of about 4 to about 18 wt. %. The conditioned feed 201 can then be passed and/or flown to a first pass and/or filtration module 240, as further described herein.

The filtration module 240 can be similar to the filtration module 140 described above with reference to the system 1000. As such, portions and/or aspects of the filtration module 240 that are similar to and/or substantially the same as portions and/or aspects of the filtration module 140 are not described in detail herein. The filtration module 240 can be any suitable filtration apparatus fluidically coupled to the feed preparation component 230 and configured to receive the conditioned feed 201 at the predetermined temperature and TDS, conduct one or more separation steps, and produce a concentrate 202 and a permeate 203. Optionally, in some embodiments, the filtration module 240 can include a storage component 241 that can be used to accommodate and/or store the conditioned feed 201 for a period of time, prior to its processing. The storage component 241 can include and/or be one or more tanks having any suitable shape, dimensions, and/or capacity. The storage component 241 can include one or more valves, inlets, or ports (not shown) configured to allow a flow of liquid into or out of the tanks of the storage component 241 (e.g., to at least partially fill one or more tanks, collect samples for quality control purposes, and/or the like).

The filtration module 240, which can also be referred to herein as the “filtration component 240” or the “first filtration module, pass, and/or component” of the processing system 2000, is disposed downstream from the feed preparation component 230, as shown in FIG. 13. The filtration module 240 includes one or more graphene oxide membrane(s). The graphene oxide membrane(s) can be disposed on the filtration module 240 according to one or more configurations. For example, in some embodiments the filtration module 240 can include two or more graphene oxide membranes disposed parallel to each other, as shown schematically in FIG. 7. The filtration module 240 can receive the conditioned feed 201 at the predetermined temperature, and then flow, direct, and/or contact the conditioned feed 201 with the graphene oxide membrane(s) included in the filtration module 240. Selected species included in the conditioned feed 201 may be allowed to diffuse across the graphene oxide membrane(s) to produce a permeate fluid such as the permeate 203. Other species present on the conditioned feed 201 may be rejected by the graphene oxide membrane(s) (e.g., being prevented from diffusing across the graphene oxide membrane(s)) and thus produce a concentrate fluid such as the concentrate 202.

In some embodiments, the graphene oxide membrane can be disposed and/or coated on a support substrate configured to provide mechanical and/or thermal stability to the graphene oxide membrane. The support substrate can comprise a plurality of flat polymer sheets combined to form a spiral filtration configuration. In some embodiments, the support substrate can be and/or include a nanofiltration (NF) membrane exhibiting characteristics similar to and/or the same as the (NF) membranes described above with reference to the filtration module 150. For example, in some embodiments the (NF) membranes serving as support to the graphene oxide membranes can exhibit a MWCO of about 0.1-1.0 kDa and can be capable of operating at temperatures up to 50 or 60° C. at a pH of 0-14. In some embodiments, the support substrate can be and/or include an ultrafiltration (UF) membrane. For example, in some embodiments, the support substrate can be and/or include an ultrafiltration (UF) membrane such as a polyethersulfone (PES, UP010P Mann+Hummel) membrane having a molecular weight cutoff (MWCO) of about 10 kDa. In a preferred embodiment the graphene oxide membrane can be disposed on support comprising a nanofiltration (NF) membrane such as a Kovalus (formerly Koch Separation Solutions) SelRO MPS-34, and/or a Unisol AMS NanoPro B-4021 membrane. The graphene oxide membranes coated on a nanofiltration (NF) membrane serving as support can be referred herein as a GO/NF membrane. In other embodiments, the support substrate can be and/or include a reverse osmosis (RO) membrane exhibiting characteristics similar to and/or the same as the (RO) membranes described above with reference to the filtration module 150. For example, in some embodiments (RO) membranes serving as support substrate to the graphene oxide membranes can be and/or include a high total dissolved solids RO membrane such as a polyamide FilmTec™ Fortilife™ XC120 (DuPont) which can operate at a total concentration of dissolved solids of up to about 12 wt. %. The graphene oxide membranes coated on a RO membrane serving as a support can be referred herein as a GO/RO membrane.

The GO/NF and the GO/RO membranes in the filtration module 240 may enable and/or facilitate processing black liquor (e.g., the conditioned feed 201) at a temperature between about 60-90° C. and an elevated pH of about 11-13 to produce and/or generate (1) a concentrate 202 that contains primarily organic species such as lignin and hemicellulose, and (2) a permeate 203 that contains primarily monovalent and divalent inorganic salts, as well as small quantities of organic species. In some embodiments, disposing and/or coating the graphene oxide (GO) membrane on the nanofiltration (NF) membrane serving as support may produce a GO/NF membrane exhibiting sufficient thermal, mechanical and chemical stability to operate at the high temperature and elevated pH of the conditioned feed 201. Similarly, in some embodiments disposing and/or coating the graphene oxide (GO) membrane on the reverse osmosis (RO) membrane serving as support may produce a GO/RO membrane exhibiting sufficient thermal, mechanical and chemical stability to operate at the high temperature and elevated pH of the conditioned feed 201. The ability to operate at such high temperatures and elevated pH stems from the thermal and chemical stability imparted by the graphene oxide membrane to the GO/NF and/or GO/RO membranes. In some embodiments, the long-term durability of the GO/NF and GO/RO membranes in the filtration module 240 may be influenced and/or impacted by the selection of a specific nanofiltration (NF) and/or reverse osmosis (RO) membranes. Said in other words, the specific properties of the nanofiltration (NF) and/or reverse osmosis (RO) membranes selected to serve as support to the GO/NF and/or GO/RO membranes can enable the filtration module 240 to operate continuously without exhibiting the degradations shown for nanofiltration (NF) and/or reverse osmosis (RO) membranes as shown, for example, in FIG. 10A. The integration of the GO/NF and/or GO/RO membranes to the processing system 2000 provides an approach to concentrating black liquor streams using pressure driven membranes, separating in a first filtration module (e.g., the filtration module 240) the majority of the large organic species present in the black liquor. This is result cannot be achieved using the conventional membranes disclosed in the prior art.

In some embodiments, the filtration module 240 can process the conditioned feed 201 in multiple stages as needed, with concentrates from each stage being fed to a subsequent stage(s). For example, as shown in FIG. 13, in some embodiments the filtration module 240 can include a primary stage 242 and one or more optional auxiliary stages 243 fluidically coupled to the primary stage 242 and disposed in series downstream from the primary stage 242. The primary stage 242 and the auxiliary stage(s) 243 can each include and/or accommodate one or more graphene oxide membrane(s) disposed according to any suitable configuration, including, for example, the parallel configuration shown in FIG. 7. The primary stage 242 can receive the conditioned feed 201, and then flow, direct, and/or contact the conditioned feed 201 with the graphene oxide membranes supported on either nanofiltration membranes serving as a support (e.g., GO/NF membrane) or reverse osmosis membranes serving as a support (GO/RO membrane) to produce a primary concentrate and a primary permeate. The primary concentrate produced by the primary stage 242 can be directly fed to the auxiliary stage(s) 243 disposed downstream. The auxiliary stage(s) 243 can receive the primary concentrate and generate the concentrate 202 and an auxiliary permeate. The primary and auxiliary permeates produced in the primary stage 242 and in the secondary stage 243, respectively, can be combined to produce the permeate 203 shown in FIG. 13.

In some embodiments, the primary stage 242 and the auxiliary stage 243 can each be configured to recirculate a portion and/or a fraction of the concentrate produce in each stage, as shown in FIG. 13. To achieve this, each stage can be fitted with recirculation pumps (not shown), to enable achieving higher recovery rates and lower the energy consumption of the processing system 2000. More specifically, the recirculation of a portion of the concentrate produced in a stage to the feed the stage allows for the earlier stages (e.g., the primary stage 242 and those auxiliary stages 243 disposed downstream close to the primary stage 242) to operate at lower solids than the final auxiliary stage 243 (e.g., the auxiliary stage 243 disposed further downstream from the primary stage 242). This improves flux by lowering the osmotic pressure of the conditioning feed 201 and prevents membrane fouling.

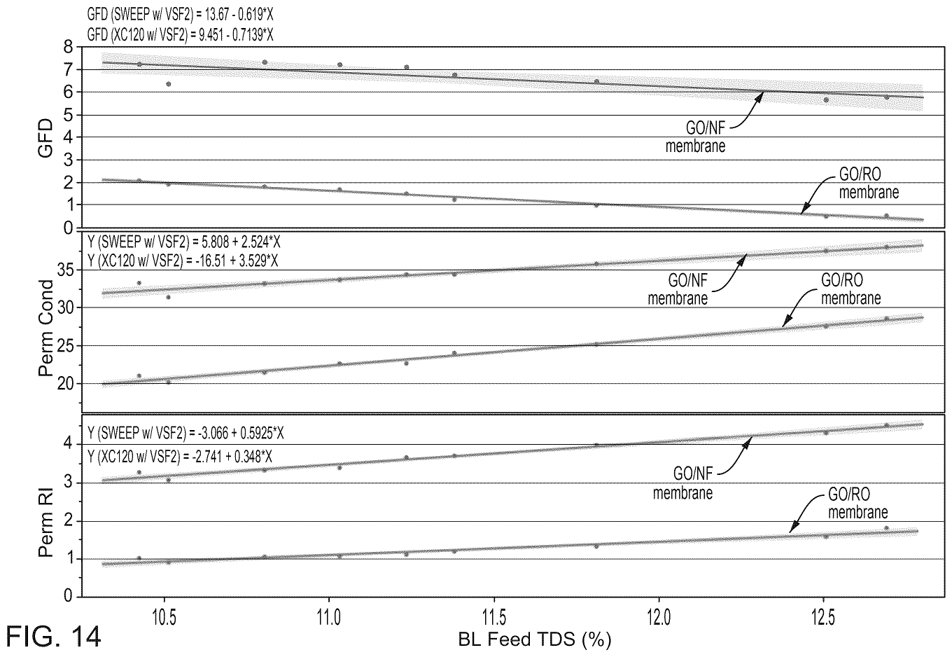

FIG. 14 shows the performance of an exemplary filtration module 240 operating in a conditioned feed 201 to produce a permeate 203, recorded at an operating temperature of 35° C. and a pressure of 750 psi. More specifically, FIG. 14 shows a plot of flux in gallons per foot square day (GFD), permeate conductivity (mS/cm) and permeate refractive index (Brix) produced by a graphene oxide membrane coated on a nanofiltration membrane serving as support (e.g., a GO/NF membrane) and a graphene oxide membrane coated on a reverse osmosis membrane serving as support (e.g., a GO/RO membrane), as a function of black liquor BL feed total dissolved solids (TDS). It is worth noting that the BL feed in FIG. 14 was produced by processing and/or conditioning a black liquor with a feed preparation component 230 including a tubular ceramic membrane with an average pore size of about 15 kDa. FIG. 14 demonstrates that the GO/NF and the GO/RO membranes can process a BL feed 201 with a wide range of total dissolved solids of between about 10% to 13%, producing permeates with a high flux and high rejection rate.

In some embodiments, the graphene oxide membrane(s) included in the filtration module 240 (e.g., the GO/NF and/or the GO/RO membranes) can exhibit a total solids rejection rate at an operating temperature of about 60-90° C. of at least about 45%, at least about 50%, at least about 55%, at least about 60%, at least about 65%, at least about 70%, at least about 75%, at least about 80%, at least about 85%, at least about 90%, or at least about 95%, inclusive of all values and ranges therebetween. In some embodiments, the graphene oxide membrane(s) included in the filtration module 240 can exhibit a total solids rejection rate of no more than about 94%, no more than about 88%, no more than about 84%, no more than about 80%, no more than about 76%, no more than about 72%, no more than about 68%, no more than about 64%, no more than about 60%, no more than about 56%, no more than about 52%, no more than about 48%, or no more than about 44%, inclusive of all values and ranges therebetween

Combinations of the above referenced ranges for the total solids rejection rate of the graphene oxide membrane(s) are also possible (e.g., at least about 60% less than about 90% or at least about 68% to less than about 80%).

In some embodiments, the graphene oxide membrane(s) included in the filtration module 240 (e.g., the GO/RO membranes and/or the GO/NF membranes) can experience an osmotic pressure of less than about 800 psi, less than about 750 psi, less than about 700 psi, less than about 650 psi, less than about 600 psi, less than about 550 psi, less than about 500 psi, less than about 480 psi, less than about 460 psi, less than about 440 psi, less than about 420 psi, less than about 400 psi, less than about 380 psi, less than about 360 psi, less than about 320 psi, less than about 300 psi, less than about 280 psi, less than about 260 psi, less than about 220 psi, less than about 200 psi, less than about 180 psi, less than about 160 psi, less than about 140 psi, less than about 120 psi, less than about 100 psi, less than about 80 psi, less than about 70 psi, less than about 60 psi, or less than about 50 psi inclusive of all values and ranges therebetween. In some embodiments, the graphene oxide membrane(s) included in the filtration module 240 can experience an osmotic pressure of at least about 50 psi, at least about 75 psi, at least about 100 psi, at least about 125 psi, at least about 150 psi, at least about 175 psi, at least about 200 psi, at least about 250 psi, at least about 300 psi, at least about 350 psi, at least about 400 psi, at least about 450 psi, at least about 500 psi, at least about 550 psi, at least about 600 psi, at least about 650 psi, at least about 700 psi, at least about 750 psi, or at least about 800 psi, inclusive of all values and ranges therebetween.

Combinations of the above referenced ranges for the osmotic pressure experienced by the graphene oxide membrane(s) in the filtration module 240 are also possible (e.g., an osmotic pressure of about 200 psi to about 750 psi, about 250 psi and about 480 psi). It is worth noting that in some embodiments, the conditioned feed 201 can be directed and/or flowed to the filtration module 240 at a pumping pressure. In some embodiments, the osmotic pressure of the conditioned feed 201 in the filtration module 240 can be a percentage of the pumping pressure. For example, in some embodiments, the osmotic pressure of the conditioned feed 201 can about 50% or less, about 45% or less, about 40% or less, about 35% or less, or about 30% or less of the pumping pressure. The osmotic pressure is less than the pumping pressure to allow some overpressure to drive flux and transport.

Turning back to FIG. 13, the processing system 2000 also includes a filtration module 250. The filtration module 250 can be any suitable filtration apparatus fluidically coupled to the filtration module 240 and configured to receive the permeate 203 and produce a concentrate 204 and a processed permeate 220. Optionally, in some embodiments, the filtration module 250 can include a storage component 251 that can be used to accommodate and/or store the permeate 203 for a period of time, prior to its processing. The storage component 251 can be similar to and/or the same as the storage component 241 described above with reference to the filtration module 240. Consequently, no further description of the storage component 251 will be provided herein.

The filtration module 250, which can also be referred to herein as the “filtration component 250” or the “second filtration module, pass, and/or component” of the processing system 2000, is disposed downstream from the filtration module 240, as shown in FIG. 13. The filtration module 250 can include one or more reverse osmosis (RO) membrane(s), one or more nanofiltration (NF) membranes, or a combination thereof. For example, in some embodiments the filtration module 250 can include one or more high total dissolved solids (RO) membranes such as a polyamide FilmTec™ Fortilife™ XC120 (DuPont) which can operate at a total concentration of dissolved solids of up to about 12 wt. %. In some embodiments, the filtration module 250 can include one or more reverse osmosis (RO) membranes such as a FilmTec™ SW30 membrane (DuPont). In some embodiments, the filtration module 250 can include one or more (NF) membranes having a MWCO of about 0.1-1.0 kDa, and capable of operating at temperatures up to 50 or 60° C. at a pH of 0-14. For example, filtration module 250 can include one or more (NF) membranes such as a Kovalus (formerly Koch Separation Solutions) SelRO MPS-34, and/or a Unisol AMS NanoPro B-4021 membrane. The (RO) membrane(s) and/or the (NF) membranes can be disposed on the filtration module 250 according to one or more configurations. For example, in some embodiments the filtration module 250 can include two or more (RO) or (NF) membranes disposed parallel to each other, as shown schematically in FIG. 7. The filtration module 250 can receive the permeate 203 and then flow, direct, and/or contact the permeate 203 with the membranes. Selected species included in the permeate 203 (e.g., some small size monovalent species such as NaOH and small amounts of divalent salts) may be allowed to diffuse across the membrane(s) to produce a processed permeate 220. Other species present on the permeate 103 (e.g., the remaining organic species that managed to diffuse across the graphene oxide membrane of the filtration module 240, divalent salts such as Na₂SO₄, and some monovalent salts) may be rejected by the membrane(s) and thus produce the concentrate 204.

In some embodiments, the filtration module 250 can process the permeate 203 in multiple stages as needed, with concentrates from each stage being fed to a subsequent stage(s). For example, as shown in FIG. 13, in some embodiments the filtration module 250 can include a primary stage 252 and one or more optional auxiliary stages 253 fluidically coupled to the primary stage 252 and disposed in series downstream from the primary stage 252. The primary stage 252 and the auxiliary stage(s) 253 can each include and/or accommodate one or more (RO) or (NF) membranes disposed according to any suitable configuration, including, for example, the parallel configuration shown in FIG. 7. The primary stage 252 can receive the permeate 203, and then flow, direct, and/or contact the permeate 203 with the (RO) and/or (NF) membranes to produce a primary concentrate and a primary permeate. The primary concentrate produced by the primary stage 252 can be directly fed to the auxiliary stage(s) 253 disposed downstream. The auxiliary stage(s) 253 can receive the primary concentrate and generate the concentrate 204 and an auxiliary permeate. The primary and the auxiliary permeate produced in the primary stage 242 and in the secondary stage 243, respectively, can be combined to produce the processed permeate 220 shown in FIG. 13.

As described above with respect to the primary stage 242 and the auxiliary stage 243, the primary stage 252 and the auxiliary stage 253 can each be configured to recirculate a portion and/or a fraction of the concentrate produce in each stage, as shown in FIG. 13. To achieve this, each stage can be fitted with recirculation pumps (not shown), to enable achieving higher recovery rates and lower the energy consumption of the processing system 2000.

The RO or NF membrane(s) in the filtration module 250 enable processing the permeate 203 to produce and/or generate (1) a concentrate 204 that contains primarily the remaining organic species, divalent salts such as sodium sulfate (Na₂SO₄) and some monovalent salts; and (2) a permeate 220 that contains primarily monovalent salts such as sodium hydroxide (NaOH) and small amounts of divalent salts. It is worth noting that because the graphene oxide membrane(s) in the filtration module 240 produce a permeate 203 with a lower level of solids and a much smaller flowrate than the level of solids and the flow rate observed with the conditioned feed 201, in some embodiments the permeate 203 can be cooled (without producing precipitation and/or fouling of the membrane) and then passed to the RO or NF membrane(s) in the filtration module 250 for removal of the remaining constituents of the conditioned feed 201. To cool the permeate 203 prior or entering the filtration module 250, the processing system 2000 can include one or more heat exchangers (not shown in FIG. 13) disposed between the filtration module 240 and 250 (e.g., one or more heat exchangers disposed downstream of the filtration module 140 and upstream the filtration module 150). These heat exchangers can be configured to receive the permeate 203 and cool and/or adjust the temperature of the permeate 203 to a suitable operating temperature for the filtration membranes included in the filtration module 250. For example, in some embodiments the permeate 203 can be cooled in a heat exchanger prior to entering the filtration module 250 such that the RO or NF membrane(s) in the filtration module 250 can operate at a temperature as high as about 50° C., as high as about 46° C., as high as about 42° C., as high as about 38° C., or as high as about 35° C., inclusive of all values and ranges therebetween.

As described above, in some embodiments the RO or NF membrane(s) included in the filtration module 250 allow processing the permeate 203 at temperature as high as about 50° C. to produce and/or generate the processed permeate 220. The processed permeate 220 contains primarily monovalent salts such as sodium hydroxide (NaOH) and small amounts of divalent salt. In some embodiments, the processed permeate 220 can have a total concentration of solids of no more than about 4.0 wt. %, no more than about 3.5 wt. %, no more than about 3.0 wt. %, no more than about 2.5 wt. %, no more than about 2.0 wt. %, no more than about 1.5 wt. %, no more than about 1.0 wt. %, no more than about 0.9 wt. %, no more than about 0.8 wt. %, no more than about 0.7 wt. %, no more than about 0.6 wt. %, no more than about 0.5 wt. %, no more than about 0.4 wt. %, no more than about 0.3 wt. %, no more than about 0.2 wt. %, or no more than about 0.1 wt. %, inclusive of all values and ranges therebetween.

Combinations of the above referenced ranges for the total concentration of solids in the processed permeate 220 are also possible (e.g., at least about 0.1 wt. % to less than about 1.0 wt. %, or at least about 0.5 wt. % to less than about 0.8 wt. %).

In some embodiments, the RO or NF membrane(s) included in the filtration module 250 can operate at a pressure (e.g., a pumping pressure) of less than about 1100 psi, less than about 1050 psi, less than about 1000 psi, less than about 950 psi, less than about 900 psi, less than about 850 psi, less than about 800 psi, less than about 750 psi, or less than about 700 psi, inclusive of all values and ranges therebetween. In some embodiments, the RO or NF membrane(s) included in the filtration module 250 can operate at a pressure (e.g., a pumping pressure) of at least about 700 psi, at least about 800 psi, at least about 900 psi, at least about 1000 psi, or at least about 1100 psi, inclusive of all values and ranges therebetween.

Combinations of the above referenced ranges for the operating pressure of the RO or NF membrane(s) in the filtration module 250 are also possible (e.g., a pressure of about 700 psi to about 1100 psi, about 850 psi and about 1050 psi).

FIG. 13 shows the processing system 2000 can optionally include a filtration module 260. In such embodiments, the filtration module 260 can be any suitable filtration apparatus fluidically coupled to the filtration module 250 (e.g., downstream from the filtration apparatus 250) and configured to receive an optional permeate 205 and produce a concentrate 206 and the processed permeate 220. In some embodiments, the filtration module 260 can include a storage component 261 that can be used to accommodate and/or store the permeate 205 for a period of time, prior to its processing. The storage component 261 can be similar to and/or the same as the storage component 241, and 251 described above with reference to the filtration modules 240 and 250. Consequently, no further description of the storage component 261 will be provided herein.

The filtration module 260, which can also be referred to herein as the “filtration component 260” or the “third filtration module, pass, and/or component” of the processing system 2000, can be disposed downstream from the filtration module 250, as shown in FIG. 13. The filtration module 260 can be similar to the filtration modules 240 and/or 250 described above. As such, portions and/or aspects of the filtration module 260 can be similar to and/or substantially the same as portions and/or aspects of the filtration module 240 and 250, and therefore are not described in detail herein. The filtration module 260 includes one or more (RO) membrane(s), preferably those with high rejection of monovalent salts. For example, in some embodiments, the filtration module 260 can include a (RO) membrane such as a polyamide FilmTec™ SW30 membrane (DuPont).

The (RO) membrane(s) can be disposed on the filtration module 260 according to one or more configurations. For example, in some embodiments the filtration module 260 can include two or more (RO) membranes disposed parallel to each other, as shown schematically in FIG. 7. The filtration module 260 can receive the permeate 205 and then flow, direct, and/or contact the permeate 205 with the (RO) membranes. Selected species included in the permeate 205 (e.g., small size monovalent salts and NaOH) may be allowed to diffuse across the (RO) membrane(s) to produce the processed permeate 220. Other species present on the permeate 205 may be rejected by the (RO) membrane(s) (e.g., some monovalent salts and remaining divalent salts) and thus produce the concentrate 206. In some embodiments, the concentrate 206 can be combined with the concentrate 204 and 202, to produce the processed concentrate 210, as shown in FIG. 13.

In some embodiments, the (RO) membrane(s) in the filtration module 260 can operate at a temperature as high as about 50° C., as high as about 46° C., as high as about 42° C., as high as about 38° C., or as high as about 35° C., inclusive of all values and ranges therebetween.

The (RO) membrane(s) included in the filtration module 260 can operate at pressures similar to the pressures disclosed above with respect to the (RO) membrane(s) included in the filtration module 250. That is, in some embodiments, the (RO) membrane(s) included in the filtration module 260 can operate at a pressure (e.g., a pumping pressure) of less than about 1100 psi, less than about 1050 psi, less than about 1000 psi, less than about 950 psi, less than about 900 psi, less than about 850 psi, less than about 800 psi, less than about 750 psi, or less than about 700 psi, inclusive of all values and ranges therebetween. In some embodiments, the (RO) membrane(s) included in the filtration module 260 can operate at a pressure (e.g., a pumping pressure) of at least about 700 psi, at least about 800 psi, at least about 900 psi, at least about 1000 psi, or at least about 1100 psi, inclusive of all values and ranges therebetween

Combinations of the above referenced ranges for the operating pressure of the (RO) membrane(s) in the filtration module 260 are also possible (e.g., a pressure of about 700 psi to about 1100 psi, about 850 psi and about 1050 psi).

As described above, the processing system 2000 comprises a reduced number of filtration passes and/or filtration modules compared to the processing system 1000. In some embodiments, the filtration modules 240, 250 and 260 of the processing system 2000 can include a combination of graphene oxide (GO) membranes, nanofiltration (NF) membranes, and reverse osmosis (RO) membranes, as summarized in FIG. 16.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The terms “substantially,” “approximately,” and “about” used throughout this Specification and the claims generally mean plus or minus 10% of the value stated, e.g., about 100 would include 90 to 110.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, the term “room temperature” can refer to a temperature of about 15° C., about 16° C., about 17° C., about 18° C., about 19° C., about 20° C., about 21° C., about 22° C., about 23° C., about 24° C., or about 25° C. In some embodiments, the room temperature is about 20° C.

As used herein, the term “substantially the same” refers to a first value that is within 10% of a second value. For example, if A is substantially the same as B, and B is 100, A can have a value ranging from 90 to 110. If A is substantially the same as B, and B is 200, A can have a value ranging from 180 to 220.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A system, comprising:
a feed preparation component configured to receive a black liquor feed having an initial total concentration of dissolved and suspended solids, the feed preparation component being further configured to remove a portion of the suspended solids from the black liquor feed to produce a conditioned feed;
a first filtration module including a graphene oxide membrane, the first filtration module being fluidically coupled to the feed preparation component and configured to contact the conditioned feed at a predetermined temperature with the graphene oxide membrane to produce a first concentrate and a first permeate;
a second filtration module fluidically coupled to the first filtration module, the second filtration module configured to receive the first permeate and produce a second concentrate and a second permeate;
a third filtration module fluidically coupled to the second filtration module, the third filtration module configured to receive the second permeate and produce a third concentrate and a third permeate; and
a fourth filtration module disposed downstream the third filtration module, the fourth filtration module configured to receive the third permeate and produce a processed permeate,
wherein the first, the second, and the third concentrate are combined to produce a processed concentrate having a total concentration of solids higher than the initial total concentration of solids.

2. The system of claim 1, wherein the feed preparation component is further configured to remove a portion of the dissolved solids from the black liquor feed to produce the conditioned feed.

3. The system of claim 1, wherein the initial total concentration of dissolved and suspended solids is between about 10 and 15 wt. % and the graphene oxide membrane produces the first permeate having a total concentration of solids of no more than about 9 wt. %.

4. The system of claim 1, wherein the graphene oxide membrane produces the first concentrate having a total concentration of solids of at least about 18 wt. %.

5. The system of claim 1, wherein the predetermined temperature is at least about 70° C.

6. The system of claim 5, wherein the graphene oxide membrane has a total solids rejection rate of at least about 50% at the predetermined temperature and a pressure of no more than 800 psi.

7. The system of claim 1 wherein the first filtration module further includes a primary stage that accommodates the graphene oxide membrane, the primary stage configured to recirculate a portion of the first concentrate to the conditioned feed.

8. The system of claim 1, wherein the first filtration module further includes:
a primary stage that accommodates a first graphene oxide membrane, the primary stage configured to (1) contact the conditioned feed with the first graphene oxide membrane to produce an intermediate concentrate, and (2) recirculate a portion of the intermediate concentrate to the conditioned feed; and
a secondary stage that accommodates a second graphene oxide membrane, the secondary stage disposed downstream from the primary stage and configured to contact the intermediate concentrate with the second graphene oxide membrane to produce the first concentrate.

9. The system of claim 8, wherein the secondary stage is configured to recirculate a portion of the first concentrate to the intermediate concentrate.

10. The system of claim 1, wherein the feed preparation component includes one or more tubular ceramic membranes.

11. The system of claim 1, wherein the second filtration module further includes:
a primary stage that accommodates a first polymeric membrane, the first stage of the second filtration module configured to (1) contact the first permeate with the first polymeric membrane to produce an intermediate concentrate, and (2) recirculate a portion of the intermediate concentrate to the first permeate; and
a secondary stage that accommodates a second polymeric membrane, the secondary stage disposed downstream from the primary stage, the secondary stage configured to (1) contact the intermediate concentrate with the second polymeric membrane to produce the second concentrate, and (2) recirculate a portion of the second concentrate to the intermediate concentrate.

12. The system of claim 11, wherein the first permeate is contacted with the first polymeric membrane at a temperature of no more than about 50° C. and a pressure of about 700-1100 psi.

13. The system of claim 11, wherein the polymeric membrane produces the second permeate having a total concentration of solids of no more than about 3 wt %.

14. The system of claim 11, wherein the polymeric membrane includes a nanofiltration membrane.

15. The system of claim 11, wherein the polymeric membrane includes a reverse osmosis membrane.

16. The system of claim 1, wherein the feed preparation component includes a heat exchanger configured to adjust the conditioned feed to the predetermined temperature.

17. A system, comprising:
a feed preparation component configured to receive a black liquor feed having an initial total concentration of dissolved and suspended solids, the feed preparation component including:
a tubular ceramic membrane configured to remove at least one of a portion of the suspended solids or a portion of the dissolved solids from the black liquor feed to produce a conditioned feed; and
a heat exchanger fluidically coupled to the tubular ceramic membrane, the heat exchanger configured to cool the conditioned feed to a predetermined temperature;
a first filtration module including a graphene oxide membrane, the first filtration module being fluidically coupled to the feed preparation component and configured to contact the conditioned feed at the predetermined temperature with the graphene oxide membrane to produce a first concentrate and a first permeate; and
a second filtration module fluidically coupled to the first filtration module, the second filtration module configured to receive the first permeate and produce a second concentrate and a processed permeate,
wherein the first concentrate and the second concentrate are combined to produce a processed concentrate having a total concentration of solids higher than the initial total concentration of solids.

18. The system of claim 17, wherein the initial total concentration of dissolved and suspended solids is between about 1 and 9 wt. %.

19. The system of claim 17, wherein the graphene oxide membrane includes a support, the support including at least one of a nanofiltration membrane, an ultrafiltration membrane, or a reverse osmosis membrane.

20. The system of claim 17, wherein the predetermined temperature is at least about 70° C.

21-29. (canceled)
